(19) United States
(12) Patent Application Publication
(10) Pub. No.: US 2006/0046094 A1
(43) Pub. Date: Mar. 2, 2006

(54) Organic electroluminescence device

(75) Inventors: Yohei Nishino, Kanagawa (JP); Katsuhiro Sato, Kanagawa (JP); Mieko Seki, Kanagawa (JP); Kiyokazu Mashimo, Kanagawa (JP); Takeshi Agata, Kanagawa (JP); Toru Ishii, Kanagawa (JP); Hiroaki Moriyama, Kanagawa (JP); Hidekazu Hirose, Kanagawa (JP); Tadayoshi Ozaki, Kanagawa (JP); Daisuke Okuda, Kanagawa (JP); Hirohito Yoneyama, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD.

(21) Appl. No.: 11/053,927

(22) Filed: Feb. 10, 2005

(30) Foreign Application Priority Data
Sep. 1, 2004 (JP) 2004-254252

(51) Int. Cl. H05B 33/12

(52) U.S. Cl. 428/690; 428/917; 313/504; 313/506

(57) ABSTRACT

The invention provides an organic electroluminescence device including an organic compound layer, wherein the organic compound layer is constituted of two or more layers at least including a light emitting layer and a buffer layer, at least one layer of the organic compound layers contains a charge-transporting polyester, which includes a repeating unit containing, as a partial structure, at least one selected from structures represented by following general formulas (I-1) and (I-2); and the buffer layer is provided adjacent to the anode and contains at least a charge injecting material:
[chem 1] 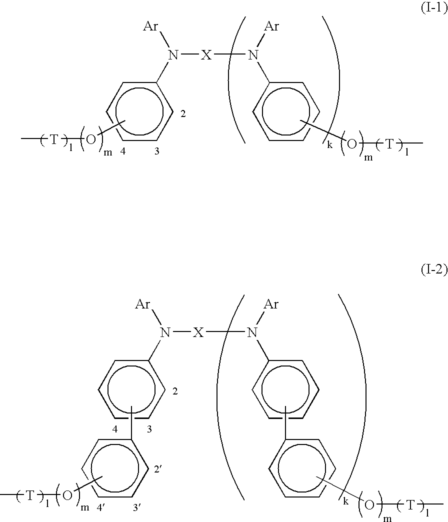 wherein, in the general formulas (I-1) and (I-2), Ar represents a substituted or non-substituted monovalent aromatic group; X represents a substituted or non-substituted divalent aromatic group; k, m and l each represents 0 or 1; and T represents a linear divalent hydrocarbon with 1 to 6 carbon atoms or a branched hydrocarbon with 2 to 10 carbon atoms.

### CROSS REFERENCE TO RELATED APPLICATION

This application claims priority under 35 USC 119 from Japanese Patent Application No. 2004-254252, the disclosure of which is incorporated by references herein.

### BACKGROUND OF THE INVENTION

1. Field of the Invention

The present invention relates to an organic electroluminescence device (hereinafter also called “organic EL device”), and more particularly to an organic electroluminescence device utilizing a specified charge transporting polymer.

2. Description of the Related Art

An electroluminescence device (hereinafter called “EL device”) is a totally solid-state light self-emitting device, and is expected for wide applications because of a high visibility and a high impact resistance. Currently devices utilizing inorganic fluorescent materials are used principally, but are associated with drawbacks of requiring a high AC driving voltage of 200 V or higher, involving a high production cost and showing an insufficient luminance.

On the other hand, researches for an EL device utilizing an organic compound were started utilizing a single crystal such as of anthracene, but such single crystal had a thickness as large as about 1 mm and required a driving voltage of 100 V or higher. For this reason, a thin film formation was tried with an evaporation method (cf. Thin Solid Films, Vol. 94, 171(1982)).

However, a thin film obtained by such method still required a driving voltage as high as 30 V, and had a low concentration of electron and hole carriers in the film, thus showing a low probability of photon generation by recombination of carriers and being incapable of providing a sufficient luminance.

It was however recently reported, in an EL device of function-separated type formed by laminating in succession thin films of an organic low-molecular compound having a positive hole transporting ability and a fluorescent organic low-molecular compound having an electron transporting ability by a vacuum evaporation method, that a high luminance of 1000 cd/m² or higher could be obtained with a low voltage of about 10 V (cf. Applied Physics Letter, Vol. 51, 913(1987)). Since this report, EL devices of laminated type have been actively developed.

In such laminate-type device, holes are injected from an electrode through a charge transport layer of a charge transporting organic compound, with a carrier balance with electrons, into a light-emitting layer of a fluorescent organic compound, and the holes and the electrons confined in the light emitting layer recombine to realize light emission of a high luminance.

However, the EL device of this type involves following drawbacks for commercialization:
(1) As it is driven with a high current density of several mA/cm², a large amount of Joule's heat is generated. Therefore, the hole-transporting low-molecular compound and the fluorescent organic low-molecular compound, formed in thin films of an amorphous state by evaporation, gradually crystallize to often result in a loss of luminance or a dielectric breakdown, thereby decreasing the service life of the device:
(2) As thin films of 0.1 μm or less of organic low-molecular compounds are formed in plural evaporation steps, pinholes tend to be generated, and a film thickness control under strictly managed conditions is essential for obtaining sufficient performance. Therefore, productivity is low and a large-area device is difficult to prepare.

For the purpose of solving the above-mentioned drawback (1), there are reported an EL device utilizing a star-burst amine capable of providing a stable amorphous glass state as a positive hole-transporting material (for example cf. 40th JSAP and Related Societies Meeting, preprint 20a-SZK-14(1993)), and an EL device employing a polymer in which triphenylamine is introduced in a side chain of polyphosphazene (cf. 42nd SPSJ Polymer Conference preprint 20J21(1993)).

However, such material, when employed singly, is unable to provide a satisfactory hole injecting property from an anode or into a light emitting layer because of presence of an energy barrier resulting from an ionization potential of the positive hole transporting material. Also the former star burst amine has a drawback of difficulty in purity improvement since purification is difficult because of a low solubility, while the latter polymer has a drawback of being unable to provide a sufficient luminance because of an insufficient current density.

Also for solving the above-mentioned drawback (2), researches have been made for an organic EL device of a single layer structure for simplifying the processes, and there are reported a device utilizing a conductive polymer such as poly(p-phenylenevinylene) (for example cf. Nature, Vol. 357, 477(1992)) and a device in which an electron transporting material and a fluorescent dye are mixed in a hole-transporting polyvinylcarbazole (cf. 38th JSAP and Related Societies Meeting, preprint 31p-g-12 (1991)), but such devices are still inferior, in luminance and light emitting efficiency, to the laminate type organic EL device utilizing organic low-molecular compounds.

Also on the manufacturing process, a coating process in wet-process preparation is investigated for the purpose of achieving a simpler manufacture, a better working property, a larger area, a lower cost and so forth, and it is reported that a device can be obtained by a casting process (50th JSAP Meeting, preprint 29p-ZP-5 (1989), 51st JSAP Meeting, preprint 28a-PB-7 (1990)), but such devices are insufficient in the manufacture or the characteristics because the charge transporting material tends to crystallize as it is poor in solubility in a solvent or mutual solubility with a resin.

Also, a display device utilizing an organic EL device, being more suitable for realizing a compact and thin structure, in comparison with other display devices such as a liquid crystal display device, it is expected for an application to a portable device driven with an internal power source. For realizing such portable device, it is important that the device can be driven for a long time with a lower electric power consumption.

On the other hand, an organic EL device has a basic layer structure having a hole transport layer (or a light emitting layer with a charge transporting function) on an ITO transparent electrode (anode), with other layers if necessary. For achieving a matching with the aforementioned application and a further energy saving, there is known a method of providing a buffer layer between the transparent electrode and the hole transport layer (or a light emitting layer with a charge transporting function) and to improve the charging injection efficiency into the hole transport layer (or a light emitting layer with a charge transporting function), thereby reducing the driving voltage. Such buffer layer is representatively constituted, for example, of PEDOT (polyethylene dioxythiophene), star burst amine, or CuPc (copper phthalocyanine).

Such buffer layer can certainly reduce the driving voltage. However, in the conditions for practical use such as a manufacture of the organic EL device having a buffer layer and a prolonged use of a device utilizing such EL device, it is found to cause various defects in the manufacture leading to a lowered yield and a deterioration of device performance in time, thus being often unsuitable for practical use.

The present invention has been made in consideration of the aforementioned drawbacks in the prior technologies, and is to provide an organic EL device that has a sufficient luminance, is excellent in stability and durability, enables a large area formation and an easy manufacture, and shows little defect formation in the manufacture and little deterioration in the device performance in time.

### SUMMARY OF THE INVENTION

According to an aspect of the present invention, there is provided an organic electroluminescence device characterized in including an organic compound layer sandwiched between a pair of electrodes which are constituted of an anode and a cathode and of which at least one is transparent or semi-transparent, wherein the organic compound layer is constituted of two or more layers at least including a light emitting layer and a buffer layer, at least one layer of the organic compound layers contains a charge transporting polyester, which includes a repeating unit containing, as a partial structure, at least one selected from structures represented by following general formulas (I-1) and (I-2), and the buffer layer is provided adjacent to the anode and contains at least a charge injecting material: 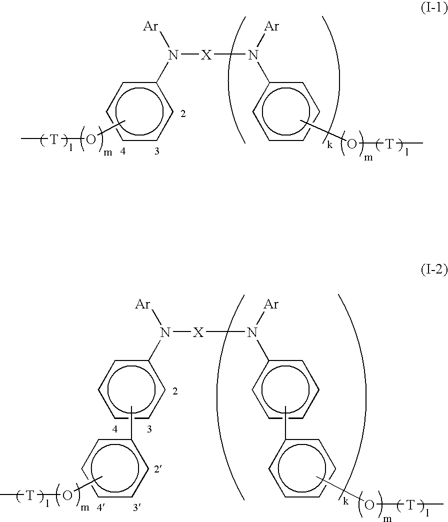
wherein, in the general formulas (I-1) and (I-2), Ar represents a substituted or non-substituted monovalent aromatic group; X represents a substituted or non-substituted divalent aromatic group; k, m and l each represents 0 or 1; and T represents a linear divalent hydrocarbon with 1 to 6 carbon atoms or a branched hydrocarbon with 2 to 10 carbon atoms.

### BRIEF DESCRIPTION OF THE DRAWINGS

FIG. 1 is a schematic cross-sectional view showing an example of a layered structure of an organic electroluminescence device of the present invention;

FIG. 2 is a schematic cross-sectional view showing another example of the layered structure of the organic electroluminescence device of the present invention;

FIG. 3 is a schematic cross-sectional view showing another example of the layered structure of the organic electroluminescence device of the present invention; and

FIG. 4 is a schematic cross-sectional view showing another example of the layered structure of the organic electroluminescence device of the present invention.

### DETAILED DESCRIPTION OF THE PREFERRED EMBODIMENTS

At first the present inventors have investigated the difficulties in case of forming, on a surface of a buffer layer formed on an anode, a hole transport layer or a light emitting layer having a charge transporting ability (hereinafter a layer formed directly on the buffer layer or indirectly across another layer may be abbreviated as “adjacent layer”) with a polymer-based charge transporting material. When the charge transporting polymer employed, in case having a vinylic skeleton (for example PTPDMA (cf. Polymer Reports, Vol. 52, 216(1995)) or a polycarbonate skeleton (for example Et-TPAPEK (cf. 43rd JSAP and Related Societies Meeting preprints 27a-SY-19, pp. 1126(1996))), it may result in an insufficient adhesion between the buffer layer and the adjacent layer thus leading to a peeling defect, or may generate pinholes or agglomeration. Such defects may result from a poor affinity of the buffer layer and the adjacent layer at the interface, and lack of flexibility of the polymer constituting the adjacent layer.

Such defects at the film formation may be avoidable, by employing a material having a highly flexible molecular structure as the charge transporting polymer to be used for forming the adjacent layer or, even in case of the material of the aforementioned molecular structure of low flexibility, by reducing the size of the molecule itself (namely reducing the molecular weight) thereby improving the flexibility of the molecule or facilitating intermolecular re-arrangement in the adjacent layer.

Also the present inventors have investigated the cause of the deterioration in time of the device performance. The charge transporting polymer employed, in case having a vinylic skeleton or a polycarbonate skeleton as mentioned above, tend to elevate the driving voltage with the lapse of time, thereby increasing the electric power consumption and further resulting in a deterioration in the light emitting characteristics.

As a cause for such phenomenon, a low-molecular component contained in the buffer layer (for example star burst amine or CuPc, or a counter ion of the ionic substance used in combination with PEDOT) bleeds in time to the adjacent layer by the Joule's heat generated at the electric field application to the device whereby the adjacent layer becomes poor to exert its intended function. Also such bleeding phenomenon indicates that the low-molecular component in the buffer layer tends to penetrate into the adjacent layer formed with the charge transporting polymer of vinylic or polycarbonate skeleton, or, stated differently, that the charge transporting polymer in the adjacent layer has a large or easily formed gaps.

It may be important, in order to suppress the bleeding phenomenon, to form a dense adjacent layer of a high heat resistance capable of avoiding the bleeding of the low-molecular component into the adjacent layer. For preventing the bleeding phenomenon, it may be important that the intermolecular gap, which accelerates the bleeding of the low-molecular component, can be filled without a space at the formation of the adjacent layer, and that a thermal relative movement of the molecules, leading to an intermolecular gap, does not occur.

Thus, from the standpoint of suppressing the bleeding, it may be important to employ, as the charge-transporting polymer constituting the adjacent layer, a material having a molecular structure of a high heat resistance (glass transition point) and a high flexibility. However, this condition is contradictory to the use of a charge-transporting polymer of a low molecular weight having a molecular structure of a low flexibility, which is one of the options adoptable for suppressing defects in the film formation.

Also for fundamental bleeding suppression, it is also conceivable to employ a material free from the low-molecular component causing the bleeding, as the charge-injecting material to be employed in the buffer layer or a component to be used in combination therewith.

In addition, the charge-transporting polymer may be required to include hopping sites, executing the charge transfer, at least by a predetermined number within a molecule, in order to secure a charge mobility influencing the light emission characteristics which are important properties of the organic EL device. Stated differently a certain molecular size (molecular weight) may be inevitably required. However, also this condition is again contradictory to the use of a charge-transporting polymer of a low molecular weight having a molecular structure of a low flexibility, which is one of options for suppressing the defects at the film formation.

Thus there is encountered a fundamentally unsolvable dilemma that a charge-transporting polymer lacking flexibility in the molecular structure is difficult to form a dense adjacent layer required for suppressing the bleeding phenomenon while a reduction in the molecular weight for suppressing the bleeding reduces the heat resistance thereby leading to an enhanced bleeding and also results in a loss in the charge mobility relating to the basic characteristics of the device.

Therefore, in producing an organic EL device with a buffer layer, for the purpose of securing the basic property of light emitting characteristics and also in consideration of the producibility and the practical durability capable of standing use over a prolonged period, the present inventors have considered that it may be important to employ, in case a material causing a bleeding is used in the buffer layer, the charge-transporting polymer for forming the adjacent layer that has not only a sufficient charge mobility but also a molecular structure of a high flexibility and a high heat resistance. Also, for fundamentally suppressing the bleeding phenomenon, the present inventors have considered that it may be effective to form the buffer layer with a component which basically does not require a low-molecular component inducing the bleeding.

More specifically, the present invention is realized in following embodiments:
<1> An organic electroluminescence device including an organic compound layer sandwiched between a pair of electrodes which are constituted of an anode and a cathode and of which at least one is transparent or semi-transparent, wherein the organic compound layer is constituted by two or more layers at least including a light emitting layer and a buffer layer, at least one layer of the organic compound layers contains at least one charge-transporting polyester, which includes a repeating unit containing, as a partial structure, at least one selected from the structures represented by following general formulas (I-1) and (I-2), and the buffer layer is provided adjacent to the anode and contains at least a charge injecting material: 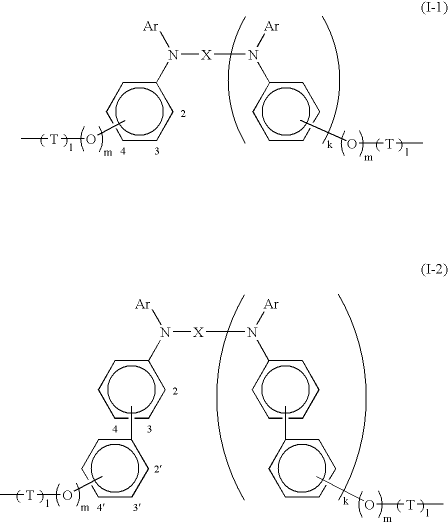
   wherein, in the general formulas (I-1) and (I-2), Ar represents a substituted or non-substituted monovalent aromatic group; X represents a substituted or non-substituted divalent aromatic group; k, m and l each represents 0 or 1; and T represents a linear divalent hydrocarbon with 1 to 6 carbon atoms or a branched hydrocarbon with 2 to 10 carbon atoms;
<2> An organic electroluminescence device described in <1>, wherein at least one of the charge injecting materials has an ionization potential of 5.2 eV or less;
<3> An organic electroluminescence device described in <1>, wherein at least one of the charge injecting materials is a charge transporting polymer having at least one selected from structural units represented by following general formulas (II-1) to (II-4): 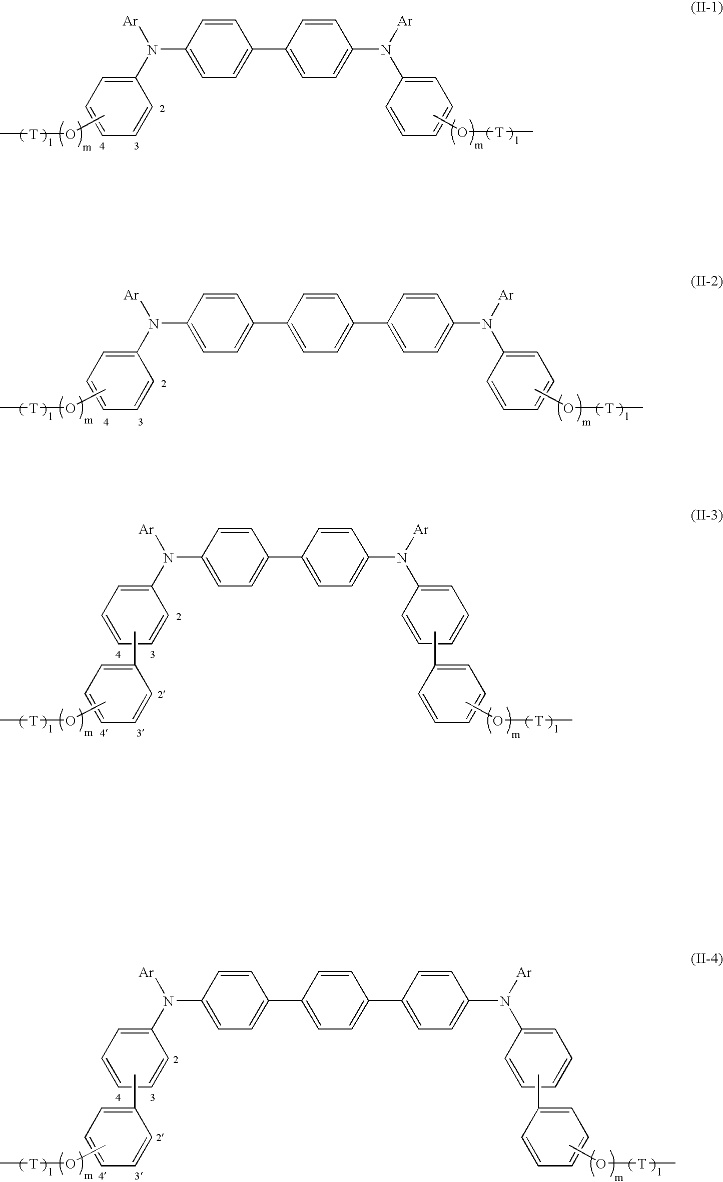
   wherein, in the formulas (II-1) to (II-4), Ar represents a substituted or non-substituted monovalent aromatic group; m and l each represents 0 or 1; and T represents a linear divalent hydrocarbon with 1 to 6 carbon atoms or a branched hydrocarbon with 2 to 10 carbon atoms;
<4> An organic electroluminescence device described in <1>, wherein at least one of the charge injecting materials is a charge-transporting polymer having a structural unit represented by a following general formula (III): 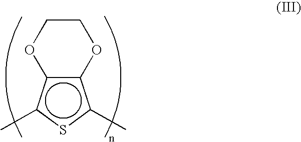
   wherein, in the general formula (III), n represents an integer within a range of 100 to 10,000.
<5> An organic electroluminescence device described in <1>, wherein at least one of the charge injecting materials is a charge-transporting material represented by a following general formula (IV): 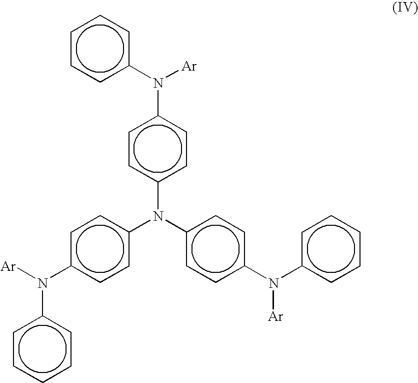
   wherein, in the general formula (IV), Ar represents a substituted or non-substituted phenyl group, a substituted or non-substituted 1-naphthyl group, or a substituted or non-substituted 2-naphthyl group;
<6> An organic electroluminescence device described in <1>, wherein at least one of the charge injecting materials is a charge-transporting material represented by a following general formula (V): 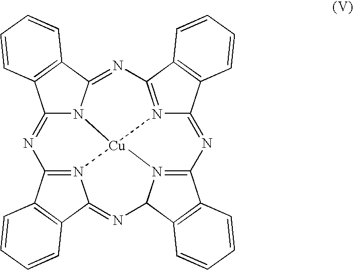
7> An organic electroluminescence device described in <1>, wherein the organic compound layer is constituted at least by the light emitting layer, the buffer layer and an electron transport layer, at least one of the light emitting layer or the electron transport layer contains at least one charge-transporting polyester including a repeating unit containing, as a partial structure, at least one selected from the structures represented by the general formulas (I-1) and (I-2), and the buffer layer is provided between the anode and the light emitting layer;
<8> An organic electroluminescence device described in <7>, wherein the light emitting layer includes a charge transporting material other than the charge transporting polyester;
<9> An organic electroluminescence device described in <7>, wherein the electron transport layer further includes a charge transporting material other than the charge transporting polyester;
<10> An organic electroluminescence device described in <9>, wherein the charge transporting material other than the charge transporting polyester is at least one selected from the group consisting of an oxadiazole derivative, a nitro-substituted fluorenone derivative, a diphenoquinone derivative, a thiapyran dioxide derivative, and a fluorenylidene methane derivative;
<11> An organic electroluminescence device described in <1>, wherein the organic compound layer is constituted at least by the light emitting layer, the buffer layer, a hole transport layer and an electron transport layer, at least one of the positive hole transport layer or the electron transport layer contains at least one charge-transporting polyester including a repeating unit containing, as a partial structure, at least one selected from the structures represented by the general formulas (I-1) and (I-2), and the buffer layer is provided between the anode and the positive hole transport layer;
<12> An organic electroluminescence device described in <9>, wherein the light emitting layer further includes a charge transporting material other than the charge transporting polyester;
<13> An organic electroluminescence device described in <1>, wherein the organic compound layer is constituted at least by the light emitting layer, the buffer layer and a hole transport layer, at least one of the hole transport layer or the light emitting layer contains at least one charge-transporting polyester including a repeating unit containing, as a partial structure, at least one selected from the structures represented by the general formulas (I-1) and (I-2), and the buffer layer is provided between the anode and the hole transport layer;
<14> An organic electroluminescence device described in <13>, wherein the light emitting layer further includes a charge transporting material other than the charge transporting polyester;
<15> An organic electroluminescence device described in <13>, wherein the hole transport layer further includes a hole transporting material other than the charge transporting polyester;
<16> An organic electroluminescence device described in <15>, wherein the hole transporting material other than the charge transporting polyester has at least one selected from structures represented by following general formulas (X-1) to (X-6); 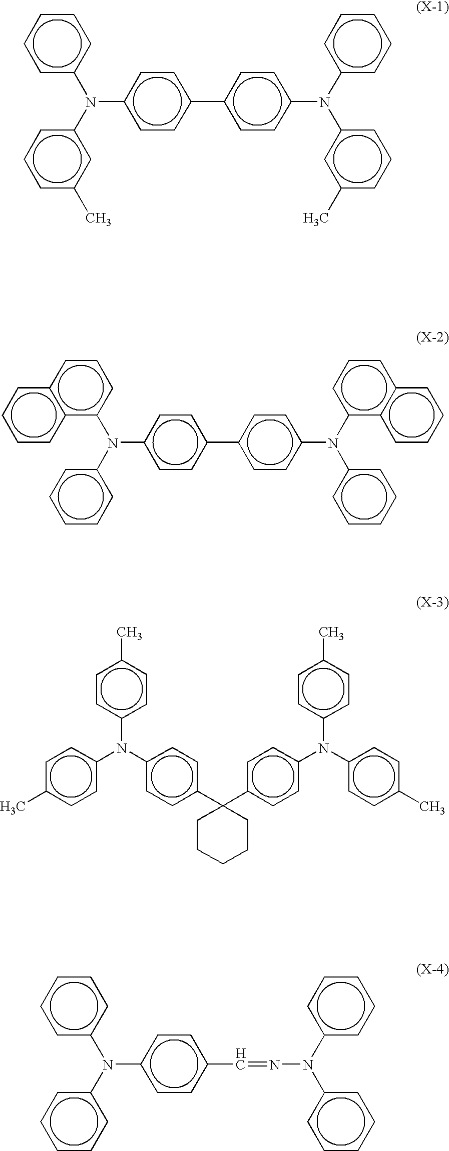 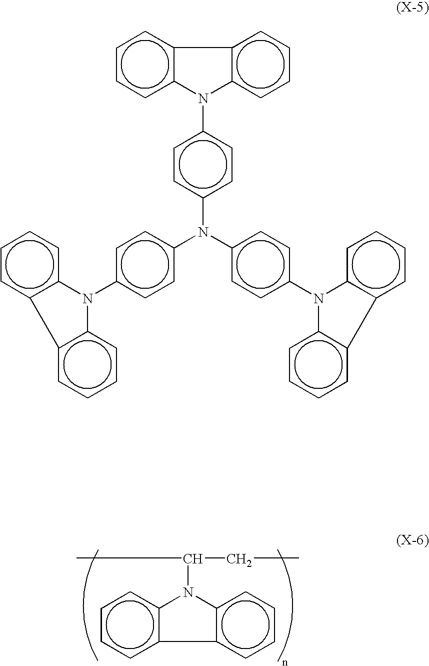
17> An organic electroluminescence device described in <1>, wherein the organic compound layer is constituted solely by the light emitting layer and the buffer layer, the light emitting layer is a light emitting layer having a charge transporting ability, which contains at least one charge-transporting polyester including a repeating unit containing, as a partial structure, at least one selected from the structures represented by the general formulas (I-1) and (I-2), and the buffer layer is provided between the anode and the light emitting layer having the charge transporting ability;
<18> An organic electroluminescence device described in <17>, wherein the light emitting layer having the charging transporting ability includes a charge transporting material other than the charge transporting polyester;
<19> An organic electroluminescence device described in <1>, wherein the charge-transporting polyester including a repeating unit containing, as a partial structure, at least one selected from the structures represented by the general formulas (I-1) and (I-2) is a charge-transporting polyester represented by a following general formula (VI-1) or (VI-2): 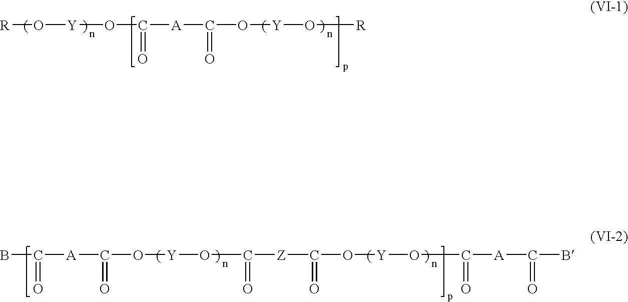
   wherein, in the formulas (VI-1) and (VI-2), A represents at least one selected from the structures represented by the general formulas (I-1) and (I-2); R represents a hydrogen atom, an alkyl group, a substituted or non-substituted aryl group or a substituted or non-substituted aralkyl group; Y represents a divalent alcohol residue; Z represents a divalent carboxylic acid residue; B and B′ each independently represent —O—(Y—O)ₙ—R or —O—(Y—O)ₙ—CO-Z—CO—R′ (in which R, Y and Z have the same meanings as above; and R′ represents an alkyl group, a substituted or non-substituted aryl group or a substituted or non-substituted aralkyl group); n represents an integer of 1-5; and p represents an integer of 5-5,000.

As explained in the foregoing, the present invention allows to provide an organic EL device that has a sufficient luminance, is excellent in stability and durability, enables a large area formation and an easy manufacture, and shows little defect formation in the manufacture and little deterioration in the device performance in time.

The organic electroluminescence device of the present invention is characterized in including an organic compound layer sandwiched between a pair of electrodes which are constituted of an anode and a cathode and of which at least one is transparent or semi-transparent, wherein the organic compound layer is constituted of two or more layers at least including a light emitting layer and a buffer layer, at least one layer of the organic compound layers contains a charge-transporting polyester, which includes a repeating unit containing, as a partial structure, at least one selected from structures represented by following general formulas (I-1) and (I-2), and the buffer layer is provided adjacent to the anode and contains at least a charge injecting material: 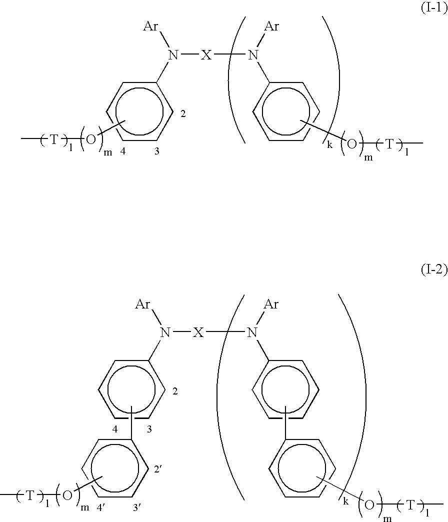
wherein, in the general formulas (I-1) and (I-2), Ar represents a substituted or non-substituted monovalent aromatic group; X represents a substituted or non-substituted divalent aromatic group; k, m and l each represents 0 or 1; and T represents a linear divalent hydrocarbon with 1 to 6 carbon atoms or a branched hydrocarbon with 2 to 10 carbon atoms.

The organic EL device of the present invention includes, in at least one layer of the organic compound layers, a charge-transporting polyester, which includes a repeating unit containing, as a partial structure, at least one selected from structures represented by following general formulas (I-1) and (I-2) (hereinafter also simply called “charge-transporting polyester”), and also includes a buffer layer containing at least one charge injecting material in contact with the anode, so that it has a sufficient luminance, also is excellent in stability and durability and can reduce the driving voltage thereby suppressing the electric power consumption in comparison with the prior technology.

Also the charge-transporting polyester, having a high mobility in an ester bonding site, shows a high flexibility in the molecular structure, and does not easily lose the flexibility of the molecular structure when the molecular weight is increased in order to secure the heat resistance.

Therefore, even in case the buffer layer contains a low-molecular component causing the bleeding phenomenon, an adjacent layer formed with such charge-transporting polyester allows to secure a sufficient charge mobility required as the charge transporting material, and also to obtain little defects such as pinholes or agglomerations and a satisfactory adhesion with the buffer layer, thereby suppressing the bleeding even in use over a prolonged period.

Also the organic EL device of the present invention, being prepared with the charge-transporting polyester, can be formed with a large area and can be prepared easily. Also, as will be explained later, the charge-transporting polyester can be given a hole transporting ability or an electron transporting ability by a suitable selection of the molecular structure. Therefore, it can be used in the hole transport layer, the light emitting layer or the charge transport layer according to the purpose.

In the general formulas (I-1) and (I-2), Ar represents a substituted or non-substituted monovalent aromatic group.

More specifically, Ar represents a substituted or non-substituted phenyl group, a substituted or non-substituted monovalent polycyclic aromatic hydrocarbon with 2 to 10 aromatic rings, a substituted or non-substituted monovalent condensed ring aromatic hydrocarbon with 2 to 10 aromatic rings, a substituted or non-substituted monovalent aromatic heterocycle, or a substituted or non-substituted monovalent aromatic group including at least an aromatic heterocycle.

In the general formulas (I-1) and (I-2), a number of the aromatic rings constituting the polycyclic aromatic hydrocarbon or the condensed ring aromatic hydrocarbon, selected as a structure represented by Ar, is not particularly restricted, but is preferably 2 to 5, and, in case of the condensed ring aromatic hydrocarbon, a totally condensed ring aromatic hydrocarbon is preferable. In the invention, the polycyclic aromatic hydrocarbon and the condensed ring aromatic hydrocarbon means a polycyclic aromatic compound defined as follows.

More specifically, the “polycyclic aromatic hydrocarbon” means a hydrocarbon compound containing two or more aromatic rings which are constituted of carbon and hydrogen and which are mutually bonded by a carbon-carbon single bond. Specific examples include biphenyl and terphenyl.

Also the “condensed ring aromatic hydrocarbon” means a hydrocarbon compound containing two or more aromatic rings which are constituted of carbon and hydrogen and which own in common a pair of mutually adjacent and mutually bonded carbon atoms. Specific examples include naphthalene, anthracene, phenanthrene and fluorene.

Also in the general formulas (I-1) and (I-2), an aromatic heterocycle selected as one of the structures represented by Ar means an aromatic ring containing an element other than carbon and hydrogen. A number (Nr) of atoms constituting such cyclic structure is preferably Nr=5 and/or 6.

Kind and number of the ring-constituting element other than C (hetero atom) are not particularly restricted, but S, N, O and the like are preferably employed, and the ring structure may contain hetero atoms of two or more kinds and two or more in number. In particular, a heterocycle having a 5-membered structure is preferably thiophene, thiophine, furan, a heterocycle obtained by substituting a carbon atom in 3- or 4-position thereof with a nitrogen atom, pyrrole, or a heterocycle obtained by substituting a carbon atom in 3- or 4-position thereof with a nitrogen atom, and a heterocycle having a 6-membered structure is preferably pyridine.

Also in the general formulas (I-1) and (I-2), an aromatic group including an aromatic heterocycle selected as one of the structures represented by Ar means a bonding group containing at least an aforementioned aromatic heterocycle in an atomic group constituting the skeleton. Such group may be entirely constituted of a conjugate system or may be partially constituted of a non-conjugate system, but it is preferably entirely constituted of a conjugate system in consideration of the charge transporting ability and the light emitting property.

A substituent on the benzene ring, the polycyclic aromatic hydrocarbon, the condensed ring aromatic hydrocarbon or the heterocycle, selected as the structure represented by Ar, can be for example a hydrogen atom, an alkyl group, an alkoxy group, a phenoxy group, an aryl group, an aralkyl group, a substituted amino group, or a halogen atom. The alkyl group preferably has 1 to 10 carbon atoms, such as a methyl group, an ethyl group, a propyl group or an isopropyl group. The alkoxy group preferably has 1 to 10 carbon atoms, such as a methoxy group, an ethoxy group, a propoxy group or an isopropoxy group.

The aryl group preferably has 6 to 20 carbon atoms, such as a phenyl group, or a toluyl group. The araylkyl group preferably has 7 to 20 carbon atoms, such as a benzyl group or a phenetyl group. A substituent of the substituted amino group can be an alkyl group, an aryl group or an aralkyl group, of which specific examples are same as described above.

In the general formulas (I-1) and (I-2), X represents a substituted or non-substituted divalent aromatic group. More specifically, X represents a substituted or non-substituted phenylene group, a substituted or non-substituted divalent polycyclic aromatic hydrocarbon with 2 to 10 aromatic groups, a substituted or non-substituted divalent condensed ring aromatic hydrocarbon with 2 to 10 aromatic groups, a substituted or non-substituted divalent aromatic heterocycle, or a substituted or non-substituted divalent aromatic group including at least an aromatic heterocycle.

The “polycyclic aromatic hydrocarbon”, the “condensed ring aromatic hydrocarbon”, the “aromatic heterocycle”, and the “aromatic group including aromatic heterocycle” are same as those explained above.

In the general formulas (I-1) and (I-2), k, m and l each represents 0 or 1; and T resents a linear divalent hydrocarbon with 1 to 6 carbon atoms or a branched divalent hydrocarbon with 2 to 10 carbon atoms, preferably a linear divalent hydrocarbon group with 2 to 6 carbon atoms or a branched hydrocarbon with 3 to 7 carbon atoms. Specific examples of the structure of T are shown in the following:

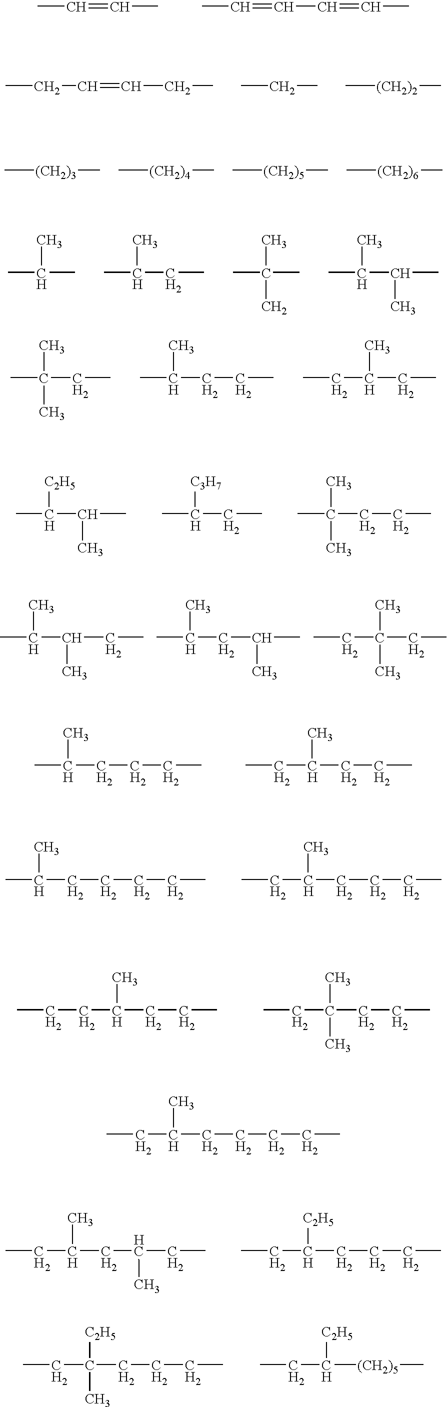

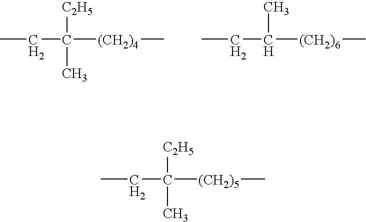

The charge transporting polyester having a repeating unit containing, as a partial structure, at least one selected from the structures represented by the general formulas (I-1) and (I-2) is preferably represented by following general formulas (VI-1) and (VI-2). The charge transporting polyester represented by the general formula (VI-1) or (VI-2) is a polyester having a hole-transporting ability (hole-transporting polyester):

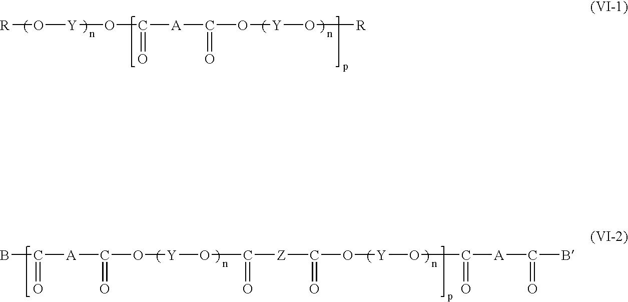

In the formulas (VI-1) and (VI-2), A represents at least one selected from structures represented by the general formulas (I-1) and (I-2); R represents a hydrogen atom, an alkyl group, a substituted or non-substituted aryl group or a substituted or non-substituted aralkyl group; Y represents a divalent alcohol residue; Z represents a divalent carboxylic acid residue; B and B′ each independently —O—(Y—O)ₙ—R or —O—(Y—O)ₙ—CO-Z-CO—O—R′ (in which R, Y and Z have the same meanings as above; and R′ represents an alkyl group, a substituted or non-substituted aryl group or a substituted or non-substituted aralkyl group); n represents an integer of 1-5; and p represents an integer of 5-5,000.

In the formulas (VI-1) and (VI-2), A represents at least one selected from structures represented by the general formulas (I-1) and (I-2), and two or more structures A may be present within a polymer.

In the formulas (VI-1) and (VI-2), R represents a hydrogen atom, an alkyl group, a substituted or non-substituted aryl group, or a substituted or non-substituted aralkyl group.

The alkyl group preferably has 1 to 10 carbon atoms, such as a methyl group, an ethyl group, a propyl group or an isopropyl group. The aryl group preferably has 6 to 20 carbon atoms, such as a phenyl group, or a toluyl group. The araylkyl group preferably has 7 to 20 carbon atoms, such as a benzyl group or a phenetyl group. A substituent of the substituted aryl group or the substituted aralkyl group can be a hydrogen atom, an alkyl group, an alkoxy group, a substituted amino group or a halogen atom.

In the formulas (VI-1) and (VI-2), Y represents a divalent alcohol residue and Z represents a divalent carboxylic acid residue. Specific examples of Y and Z include those selected from following formulas (1) to (7).

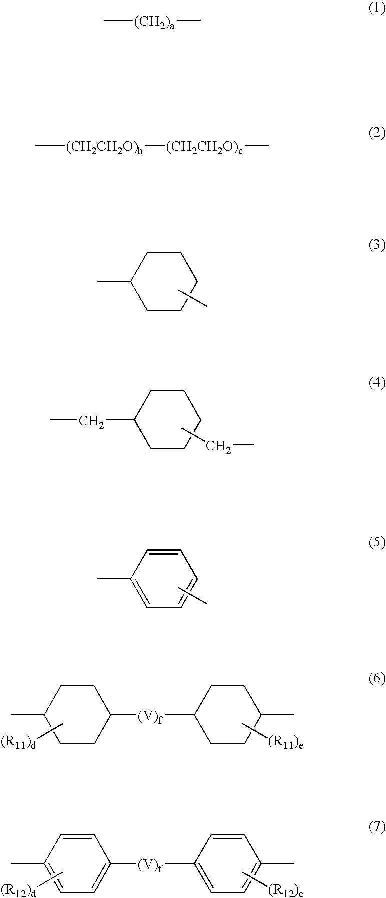

In the formulas (1)-(7), R₁₁ and R₁₂ each independently represents a hydrogen atom, an alkyl group with 1 to 4 carbon atoms, an alkoxy group with 1 to 4 carbon atoms, a substituted or non-substituted phenyl group, a substituted or non-substituted aralkyl group, or a halogen atom; a, b, c each represents an integer of 1-10; d and e each represents an integer of 0, 1 or 2; f each represents an integer of 0 or 1; and V represents a group selected from following formulas (8) to (18).

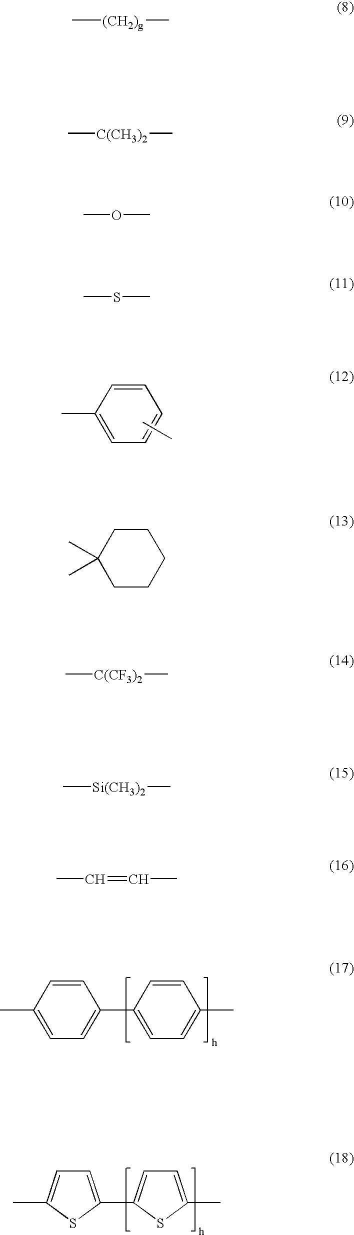

In formulas (8) to (18), g each represents an integer of 1-10; and h each represents an integer of 0-10.

In the general formulas (VI-1) or (VI-2), n represents an integer 0 or 1; and p representing a degree of polymerization is within a range of 5 to 5,000, preferably 10 to 1,000.

The charge-transporting polyester employed in the present invention preferably has a weight-average molecular weight M_{w} within a range of 5,000 to 1,000,000, more preferably 10,000 to 300,000.

The charge transporting polyester employed in the invention, in case of hole transporting ability, can be synthesized by a hole-transporting monomer represented by a following formula (VII-1) or (VII-2) by a known method described for example in Jikken Kagaku Koza, 4th edition, Vol. 28 (Maruzen, 1992).

In the formula (VII-1) or (VII-2), A′ represents a hydroxyl group, a halogen atom, an alkoxyl group [—OR₁₃ (wherein R₁₃ represents an alkyl group (such as a methyl group or an ethyl group))], and Ar, X, T, k, l and m have same meanings as in the general formulas (I-1) and (I-2).

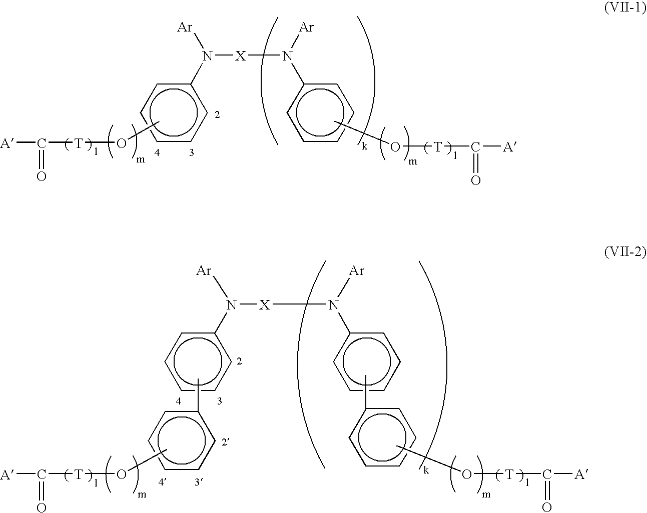

The hole-transporting polyester represented by the general formula (VI-1) can be synthesized in the following manner.

In case A′ is a hydroxyl group, a hole-transporting monomer represented by a formula (VII-1) or (VII-2) is mixed with a dihydric alcohol represented by HO—(Y—O)ₘ—H in an approximately equimolar amount and polymerized with an acid catalyst. The acid catalyst can be that employed in an ordinary esterification reaction such as sulfuric acid, toluenesulfonic acid or trifluoroacetic acid, and is employed within a range of 1/10,000 to 1/10 parts by weight with respect to 1 part by weight of the hole-transporting monomer, preferably 1/1,000 to 1/50 parts by weight. A solvent capable of forming an azeotrope with water is preferably employed for eliminating water formed in the polymerization, and there can be advantageously employed toluene, chlorobenzene, or 1-chloronaphthalene which is employed within a range of 1 to 100 parts by weight, preferably 2 to 50 parts by weight, with respect to 1 part by weight of the hole-transporting monomer. A reaction temperature can be selected arbitrarily, but the reaction is preferably executed at the boiling point of the solvent in order to eliminate the water generated in the polymerization.

After the reaction, in case a solvent is not employed, the product is dissolved in a solvent capable dissolving. In case a solvent is employed, the reaction solution is dropwise added to a poor solvent in which a polymer is not easily dissolved, for example an alcohol such as methanol or ethanol, or acetone, thereby precipitating and separating the hole-transporting polyester, which is then sufficiently washed with water or an organic solvent and dried. If necessary, there may be repeated a reprecipitation process of dissolving the polyester in a suitable organic solvent and dripping it into a poor solvent thereby precipitating the hole-transporting polyester. Such reprecipitation process is preferably executed under an efficient agitation for example with a mechanical stirrer. The solvent for dissolving the hole-transporting polyester at the reprecipitation process is employed within a range of 1 to 100 parts by weight, preferably 2 to 50 parts by weight with respect to 1 part by weight of the hole-transporting polyester. Also the poor solvent is employed within a range of 1 to 1,000 parts by weight, preferably 10 to 500 parts by weight with respect to 1 part by weight of the hole-transporting polyester.

In case A′ is a halogen, a hole-transporting monomer represented by a formula (VII-1) or (VII-2) is mixed with a dihydric alcohol represented by HO—(Y—O)ₘ—H in an approximately equimolar amount and polymerized with an organic basic catalyst such as pyridine or triethylamine. The organic basic catalyst is employed within a range of 1 to 10 equivalents, preferably 2 to 5 equivalents with respect to 1 equivalent of the positive hole-transporting monomer. An effective solvent is for example methylene chloride, tetrahydrofuran (THF), toluene, chlorobenzene or 1-chloronaphthalene, and is employed within a range of 1 to 100 parts by weight, preferably 2 to 50 parts by weight, with respect to 1 part by weight of the hole-transporting monomer. A reaction temperature can be selected arbitrarily. After the polymerization, purification is executed by a reprecipitation process as explained above.

In case of a dihydric alcohol of a high acidity such as a bisphenol, an interfacial polymerization can also be employed. More specifically, a dihydric alcohol is added to water and dissolved by adding an equimolar amount of a base, and polymerization can be executed by adding a solution of a hole-transporting monomer of an equimolar amount to the dihydric alcohol, under vigorous agitation. Water is employed within a range of 1 to 1,000 parts by weight, preferably 2 to 500 parts by weight with respect to 1 part by weight of the hole-transporting monomer. An effective solvent is for example methylene chloride, dichloroethane, trichloroethane, toluene, chlorobenzene or 1-chloronaphthalene. A reaction temperature can be selected arbitrarily. In order to accelerate the reaction, it is effective to employ an interphase movable catalyst such as an ammonium salt or a sulfonium salt. The interphase movable catalyst is employed within a range of 0.1 to 10 parts by weight, preferably 0.2 to 5 parts by weight with respect to 1 part by weight of the hole-transporting monomer.

In case A′ is an alkoxyl group, the synthesis can be executed by adding, to a hole-transporting monomer represented by a formula (VII-1) or (VII-2), a dihydric alcohol represented by HO—(Y—O)ₘ—H in an excess amount and executing an ester exchange under heating in the presence of a catalyst for example an inorganic acid such as sulfuric acid or phosphoric acid, titanium alkoxyde, a calcium or cobalt salt of acetic acid or carbonic acid, a zinc or lead oxide. The dihydric alcohol is employed within a range of 2 to 100 equivalents, preferably 3 to 50 equivalents with respect to 1 equivalent of the hole-transporting monomer.

The catalyst is employed within a range of 1/10,000 to 1 part by weight, preferably 1/1,000 to 1/2 parts by weight with respect to 1 part by weight of the hole-transporting monomer represented by a formula (VII-1) or (VII-2). The reaction is executed at a temperature of 200 to 300° C., and the completion of ester exchange from alkoxyl group into —O—(Y—O)ₘH, the reaction is preferably executed under a reduced pressure in order to accelerate a polymerization by cleavage of HO—(Y—O)ₘH. It is also possible to employ a high-boiling solvent capable of forming an azeotrope with HO—(Y—O)ₘH such as 1-chloronaphthalene, thereby executing the reaction at the atmospheric pressure under azeotropic elimination of HO—(Y—O)ₘH.

Also the hole-transporting polyester represented by the general formula (VI-2) can be synthesized utilizing a hole-transporting monomer represented by a formula (VIII-1) or (VIII-2).

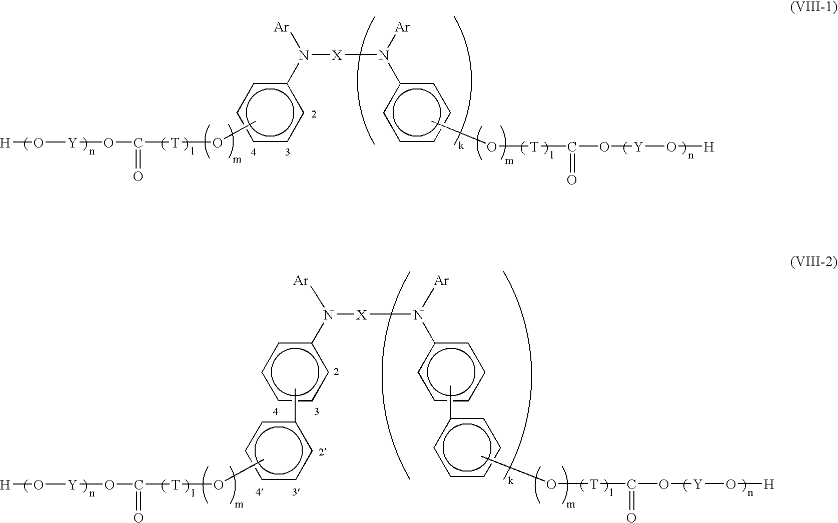

In the formula (VIII-1) and (VIII-2), Ar, X, Y, T, k, l, m and n have same meanings as described above.

The hole-transporting polyester represented by the general formula (VI-2) can be synthesized in the following manner.

At first, a hole-transporting monomer represented by a formula (VII-1) or (VII-2) (wherein A′ may be a hydroxyl group, a halogen, or an alkoxyl group) is reacted with an excess amount of a dihydric alcohol represented by HO—(Y—O)ₘH to generate a hole-transporting monomer represented by a formula (VIII-1) or (VIII-2).

Then the hole-transporting polyester represented by the general formula (VI-2) can be synthesized in the same manner as in the synthesis of the hole-transporting polyester of the general formula (VI-1) by reacting with a divalent carboxylic acid or a divalent carboxylic acid halide and employing a hole-transporting monomer represented by a formula (VIII-1) or (VIII-2) instead of the hole-transporting monomer represented by a formula (VII-1) or (VII-2).

In the following there will be explained a layer structure of the organic EL device of the invention.

The organic EL device of the invention has a layer structure including a pair of electrodes which are constituted of an anode and a cathode and of which at least one is transparent or semi-transparent, and an organic compound layer including two or more layers containing a light emitting layer and a buffer layer, sandwiched between the pair of electrodes.

The buffer layer includes at least a charge injecting material, and is provided adjacent to the anode. Also at least one of the organic compound layers includes at least an aforementioned charge-transporting polyester and a light emitting polymer.

In the organic EL device of the invention, in case the organic compound layer is constituted solely of the buffer layer and the light emitting layer, such light emitting layer means a light emitting layer having a charge transporting ability, and the light emitting layer having the charge transporting ability is constituted by containing the charge-transporting polyester.

Also in case the organic compound layer includes one or more layers in addition to the buffer layer and the light emitting layer (function-separated type with three or more layers), a layer other than the buffer layer and the light emitting layer is a carrier transport layer, namely a hole transport layer, an electron-transport layer or a hole transport layer and an electron transport layer, and the charge-transporting polyester is contained in at least one of these layers.

More specifically, the organic compound layer may assumed, for example, a configuration including at least a buffer layer, a light emitting layer and an electron transport layer, a configuration including at least a buffer layer, a positive hole transport layer, a light emitting layer and an electron transport layer, or a configuration including at least a buffer layer, a hole transport layer and a light emitting layer. In such case, the aforementioned charge-transporting polyester is preferably contained in at least one of these layers (hole transport layer, charge transport layer and light emitting layer). Also in the organic EL device of the invention, the light emitting layer may contain a charge transporting material (a hole-transporting material or an electron-transporting material other than the aforementioned charge-transporting polyester), and the details of such charge transporting material will be explained later.

In the following, the organic EL device of the invention will be explained in detail with reference to the accompanying drawings, but such explanation will not be restrictive.

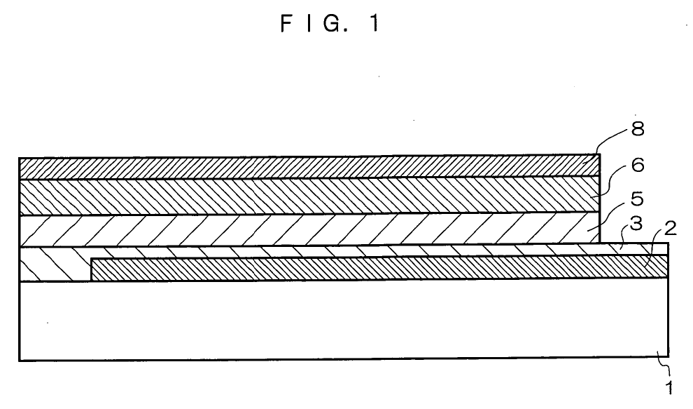

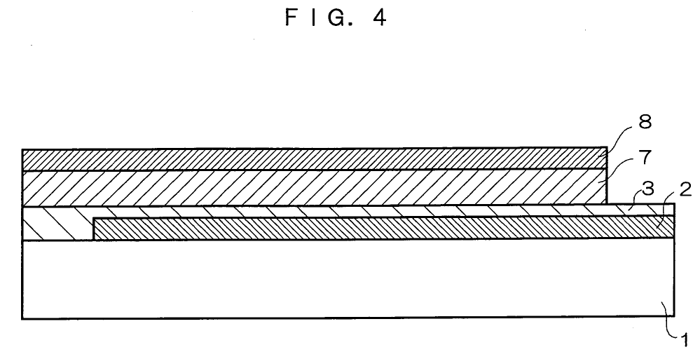

FIGS. 1 to 4 are schematic cross-sectional views for explaining the layer structure of the organic EL device of the invention, in which FIGS. 1, 2 and 3 show examples where the organic compound layer has 3- or 4-layered structure, while FIG. 4 shows an example where the organic compound layer has 2-layered structure. In FIGS. 1 to 4, like members are represented by like numbers.

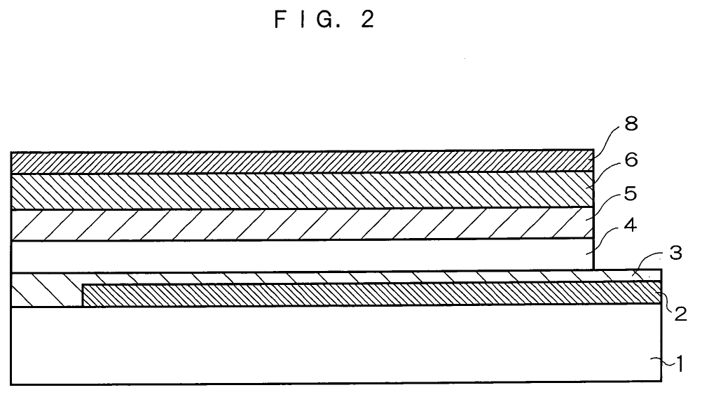

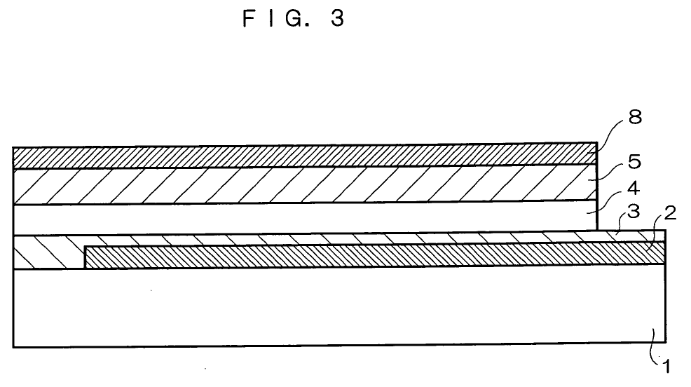

An organic EL device shown in FIG. 1 is formed by laminating, on a transparent insulating substrate 1, in succession a transparent electrode 2, a buffer layer 3, a light emitting layer 5, an electron transport layer 6 and a rear electrode 8. An organic EL device shown in FIG. 2 is formed by laminating, on a transparent insulating substrate 1, in succession a transparent electrode 2, a buffer layer 3, a hole transport layer 4, a light emitting layer 5, an electron transport layer 6 and a rear electrode 8. An organic EL device shown in FIG. 3 is formed by laminating, on a transparent insulating substrate 1, in succession a transparent electrode 2, a buffer layer 3, a hole transport layer 4, a light emitting layer 5, and a rear electrode 8. An organic EL device shown in FIG. 4 is formed by laminating, on a transparent insulating substrate 1, in succession a transparent electrode 2, a buffer layer 3, a light emitting layer 7 with a charge transporting ability, and a rear electrode 8.

In FIGS. 1 to 4, the transparent electrode 2 constitutes an anode, and the rear electrode 8 constitutes a cathode. In the following, each component will be explained in detail.

A layer containing the aforementioned charge transporting polyester employed in the invention can be, in case of the layer configuration of the organic EL device shown in FIG. 1, the light emitting layer 5 or the electron transport layer 6, or, in case of the layer configuration of the organic EL device shown in FIG. 2, the hole transport layer 3, the light emitting layer 5 or the electron transport layer 6. Also it can be, in case of the layer configuration of the organic EL device shown in FIG. 3, the hole transport layer 3, or the light emitting layer 7 having the charge transporting ability, or, in case of the layer configuration of the organic EL device shown in FIG. 4, the light emitting layer 7 having the charge transporting ability.

In the layer configurations of the organic EL device shown in FIGS. 1 to 4, the transparent insulating substrate 1 is preferably transparent in order to transmit the emitted light, and can be constituted for example of glass or plastics but such examples are not restrictive. The transparent electrode 2 is preferably transparent in order to transmit the emitted light as in the transparent insulating substrate and preferably has a large work function (ionization potential) in order to inject holes, and may be constituted, for example, of an oxide film such as indium tin oxide (ITO), tin oxide (NESA), indium oxide, zinc oxide, or an evaporated or sputtered film of gold, platinum or palladium, but such examples are not restrictive.

The buffer layer 3 is formed in contact with the anode (transparent electrode 2 shown in FIGS. 1 to 4) and contains at least a charge injecting material. The charge injecting material preferably has an ionization potential of 5.2 eV or less, preferably 5.1 eV or less, in order to improve a charge injection into a layer provided in contact with a surface of the buffer layer 3 opposite to the surface thereof in contact with the anode (namely the light emitting layer 5 in FIG. 1, the hole transport layer in FIG. 2 or 3, or the light emitting layer 7 having the charge transport ability in FIG. 4). The buffer layer 3 is not restricted in a number of constituting layers thereof, but is preferably formed with 1 or 2 layers.

Such charge injecting material can be a charge transporting polymer including at least one of structural units represented by following general formulas (II-1) to (II-4), a charge transporting polymer including a structural unit represented by a following general formula (III), a charge transporting polymer represented by a following general formula (IV), or a charge transporting material represented by a following general formula (V).

The buffer layer 3 may be solely constituted of any one of these charge injecting materials, or constituted of a mixture of two or more thereof, and may further contain a material not having a charge injecting property such as a binder resin, if necessary.

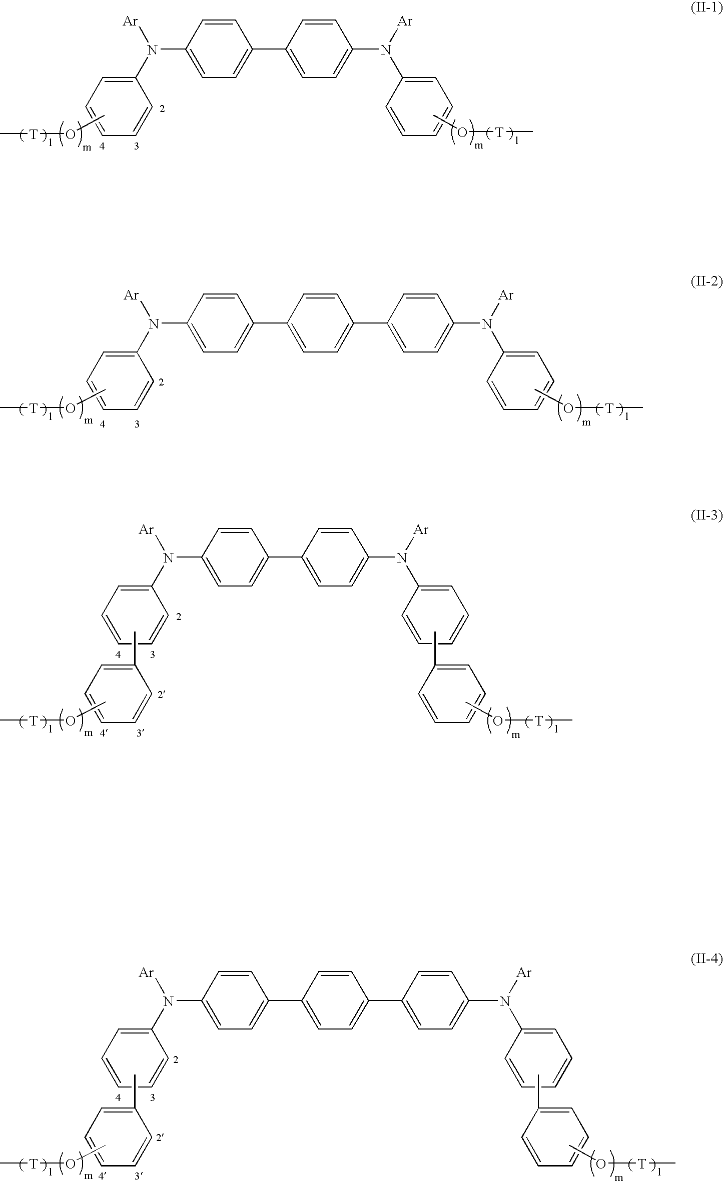

In the general formulas (II-1) to (II-4), Ar represents a substituted or non-substituted monovalent aromatic group; m and l each independently represents 0 or 1; and T represents a linear divalent hydrocarbon with 1 to 6 carbon atoms or a branched hydrocarbon with 2 to 10 carbon atoms. In the general formulas (II-1) to (II-4), specific examples of Ar and T are same as those for Ar and T in the general formulas (I-1) and (I-2).

The structure shown in the general formula (II-1) or (II-2) indicates a structure in which a portion X in the general formula (I-1) is constituted by biphenyl or terphenyl, and the structure shown in the general formula (II-3) or (II-4) indicates a structure in which a portion X in the general formula (I-2) is constituted by biphenyl or terphenyl.

Also a charge transporting polymer represented by the general formulas (II-1) to (II-4), employed as the charging injecting material, allows to dispense with a low-molecular component which causes bleeding in the formation of the buffer layer, thereby enabling to fundamentally avoid the bleeding phenomenon.

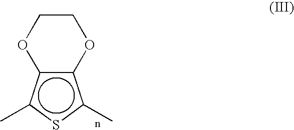

In the general formula (III), n represents an integer within a range of 100 to 10,000, preferably 1,000 to 2,500. The compound represented by the general formula (III) is so-called PEDOT (polyethylene-dioxythiophene), which cannot singly secure a sufficient conductivity and is therefore used in combination with an ionic substance containing a counter ion (such as Na ion) such as PSS (polystyrenesulfonic acid).

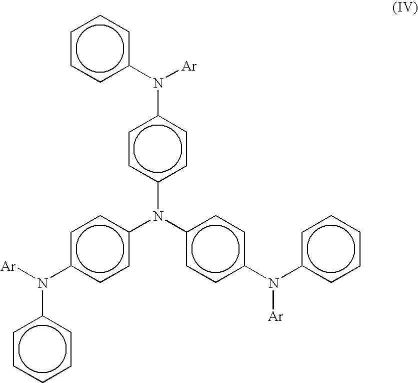

In the general formula (IV), Ar represents a substituted or non-substituted phenyl group, a substituted or non-substituted 1-naphthyl group, or a substituted or non-substituted 2-naphthyl group.

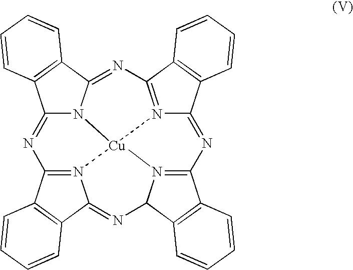

In case the buffer layer 3 includes a charge transporting polymer having at least one of structural units represented by the general formulas (II-1) to (II-4) (such polymer may hereinafter be called “first charge transporting polymer”), such first charge transporting polymer is preferably such that at least one of the structural units represented by the general formulas (II-1) to (II-4) constitutes a part of the polymer or is bonded to the polymer. In such case, in the structural unit constituting a part of the polymer or bonded to the polymer, a phosphorescence emitting portion or a fluorescence emitting portion may constitute a main chain of the first charge transporting polymer or a side chain of the first charge transporting polymer.

The expression “constituting a part of the polymer” means that any one of the structural units represented by the general formulas (II-1) to (II-4) constitutes at least one of the repeating units of the first charge transporting polymer.

In such case, when the first charge transporting polymer is a copolymer constituted of repeating units of two or more kinds, at least one of the monomers employed in synthesizing the first charge transporting polymer includes any one of the structural units represented by the general formulas (II-1) to (II-4). Also any one of the structural units represented by the general formulas (II-1) to (II-4) may constitute a main chain of the first charge transporting polymer or may constitute a side chain (such as a pendant group) thereof.

Also the expression “bonded to the polymer” means that, in the first charge transporting polymer of a polymer structure substantially free from the structural units represented by the general formulas (II-1) to (II-4) as a repeating unit, any one of the structural units represented by the general formulas (II-1) to (II-4) may be bonded in any amount and in any form.

In such case, the first charge transporting polymer includes a polymer structure basically free from the structural units represented by the general formulas (II-1) to (II-4) as a repeating unit and having any one of the structural units represented by the general formulas (II-1) to (II-4) in the main chain or the side chain (including a pendant group), but such configuration is not restrictive.

The first charge transporting polymer including at least one of the structural units represented by the general formulas (II-1) to (II-4) is not particularly restricted in the molecular structure, but can be, for example, (1) a polymer including the aforementioned structural unit in a main chain of polyester, polyether or polyurethane and/or a derivative thereof, (2) a polymer including the aforementioned structural unit in a side chain of polystyrene, poly(meth)acrylic acid and/or a derivative thereof, or (3) a polymer formed by combining the structures (1) and (2).

Such first charge transporting polymer preferably has a polymerization degree within a range of 5 to 5,000, more preferably 10 to 1,000, and preferably a weight-average molecular weight within a range of 5,000 to 1,000,000 and more preferably 10,000 to 300,000.

In case the buffer layer 3 includes a charge transporting polymer having at least a structural unit represented by the general formula (III) (such polymer may hereinafter be called “second charge transporting polymer”), such second charge transporting polymer is used in mixture with an ionic substance such as polystyrenesulfonic acid (PSS) in order to improve the charge injecting ability of the buffer layer 3.

As such mixture containing the second charge transporting polymer and polystyrenesulfonic acid, there can be employed a known material such as Baytron P (manufactured by Bayer AG; a mixed aqueous dispersion containing polyethylene dioxide thiophene and polystyrenesulfonic acid).

In case the buffer layer 3 includes a charge transporting material represented by the general formula (IV), Ar in the general formula (IV) is selected from a substituted or non-substituted phenyl group, a substituted or non-substituted 1-naphthyl group, and a substituted or non-substituted 2-naphthyl group.

In such case, a substituent on the substituted phenyl group can be for example a hydrogen atom, an alkyl group, an alkoxy group, a phenoxy group, an aryl group, an aralkyl group, a substituted amino group, or a halogen atom. The alkyl group preferably has 1 to 10 carbon atoms, such as a methyl group, an ethyl group, a propyl group or an isopropyl group. The alkoxy group preferably has 1 to 10 carbon atoms, such as a methoxy group, an ethoxy group, a propoxy group or an isopropoxy group. The aryl group preferably has 6 to 20 carbon atoms, such as a phenyl group, or a toluyl group. The araylkyl group preferably has 7 to 20 carbon atoms, such as a benzyl group or a phenetyl group. A substituent of the substituted amino group can be an alkyl group, an aryl group or an aralkyl group, of which specific examples are same as described above.

In the layered structure of the organic EL device shown in FIGS. 1 and 2, the electron transport layer 6 may be singly formed by the aforementioned charge transporting polyester provided with a desired function (electron transporting ability), but may also be formed by mixing and dispersing an electron transporting material other than the charge transporting polyester within a range of 1 to 50 wt. % for regulating the electron mobility, for the purpose of further improving the electrical characteristics.

Such electron transporting material can advantageously be an oxadiazole derivative, a nitro-substituted fluorenone derivative, a diphenoquinone derivative, a thiopyrandioxide derivative or a fluorenylidene methane derivative. Preferred specific examples are shown by following compounds (IX-1) to (IX-3), but such examples are not restrictive. In case the electron transport layer 6 is formed without the charge transporting polyester, it is formed with such electron transporting material.

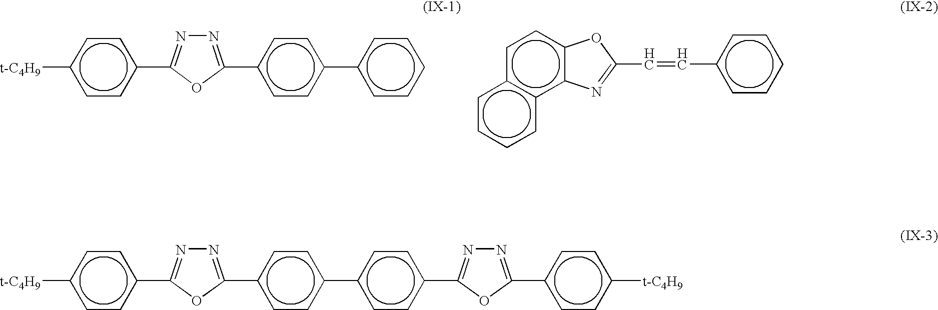

In the layered structure of the organic EL device shown in FIGS. 2 and 3, the hole transport layer 3 may be singly formed by the aforementioned charge transporting polyester provided with a desired function (hole-transporting ability), but may also be formed by mixing and dispersing a hole-transporting material other than the charge transporting polyester within a range of 1 to 50 wt. % for regulating the hole mobility.

Such positive hole-transporting material can advantageously be a tetraphenylenediamine derivative, a triphenylamine derivative, a carbazole derivative, a stilbene derivative, an arylhydrazone derivative, or a porphyrin derivative, and particularly preferred specific examples are shown by following compounds (X-1) to (X-6), but a tetraphenylenediamine derivative is preferred because of a satisfactory mutual solubility with the charge transporting polyester. Also another general-purpose resin may be used in a mixture. In case the hole transport layer 3 is formed without the charge transporting polyester, it is formed with such hole-transporting material. In the compound (X-6), n (integer) is preferably within a range of 10 to 100,000 and more preferably 1,000 to 50,000.

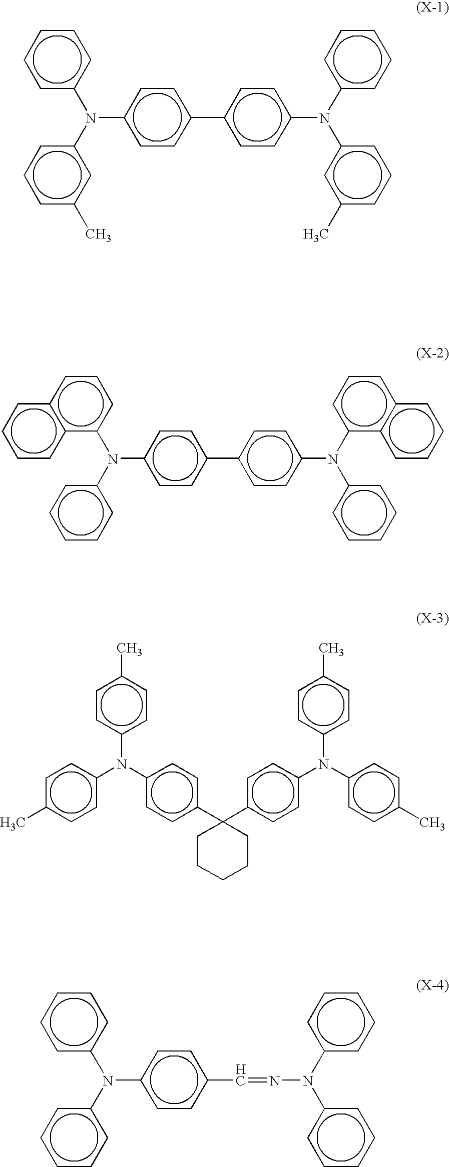

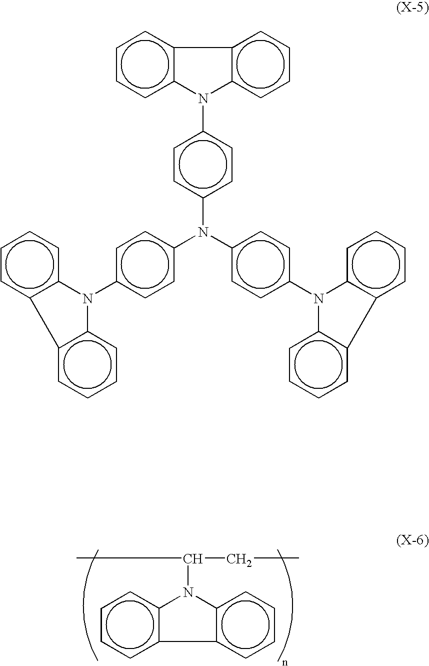

In the layered structure of the organic EL device shown in FIGS. 1, 2 and 3, the light emitting layer 5 employs, as a light emitting material, a compound showing a high fluorescence quantum yield in a solid state. In case the light emitting material is an organic low-molecular compound, it is required that a satisfactory film formation is possible by vacuum evaporation or by coating and drying a solution or a dispersion containing the low-molecular compound and a binder resin. Also in case of a high-molecular compound, it is required that a satisfactory film formation is possible by coating and drying a solution or a dispersion containing such high-molecular compound itself.

In case of an organic low-molecular compound, it can advantageously be a chelate organometallic complex, a polycyclic or condensed-ring aromatic compound, a perylene derivative, a coumarine derivative, a styrylarylene derivative, a silol derivative, an oxazole derivative, an oxathiazole derivative or an oxadiazole derivative, and, in case of a high-molecular compound, it can advantageously be a polyparaphenylene derivative, a polyparaphenylenevinylene derivative, a polythiophene derivative, a polyacetylene derivative or a polyfluorene derivative. Preferred specific examples include following compounds (XI-1) to (XI-17), but such examples are not restrictive.

In the structures (XI-13) to (XI-17), Ar represents a monovalent or divalent group of a structure similar to Ar in the general formulas (I-1) and (I-2), X representing a substituted or non-substituted divalent aromatic group; n and x each represents an integer of 1 or larger; and y represents 0 or 1.

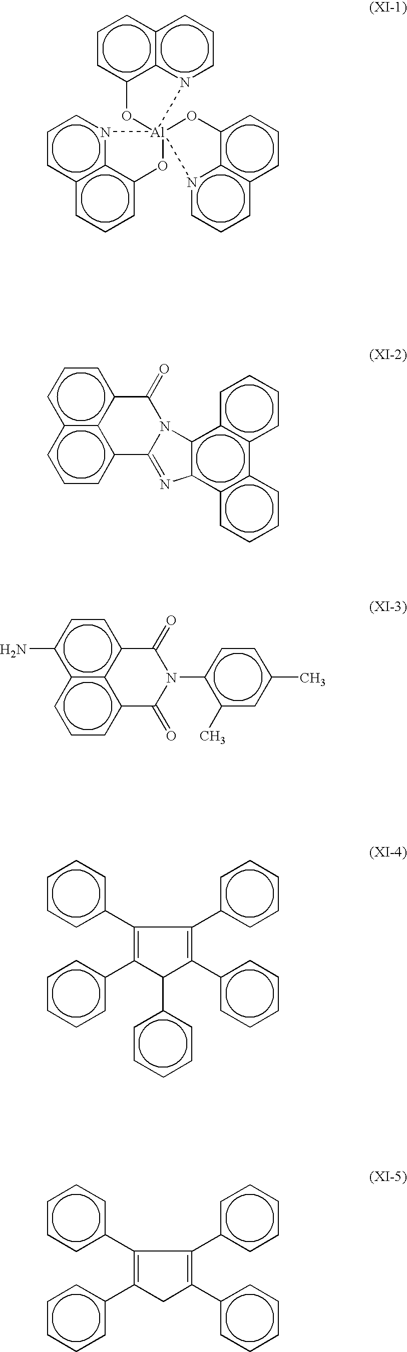

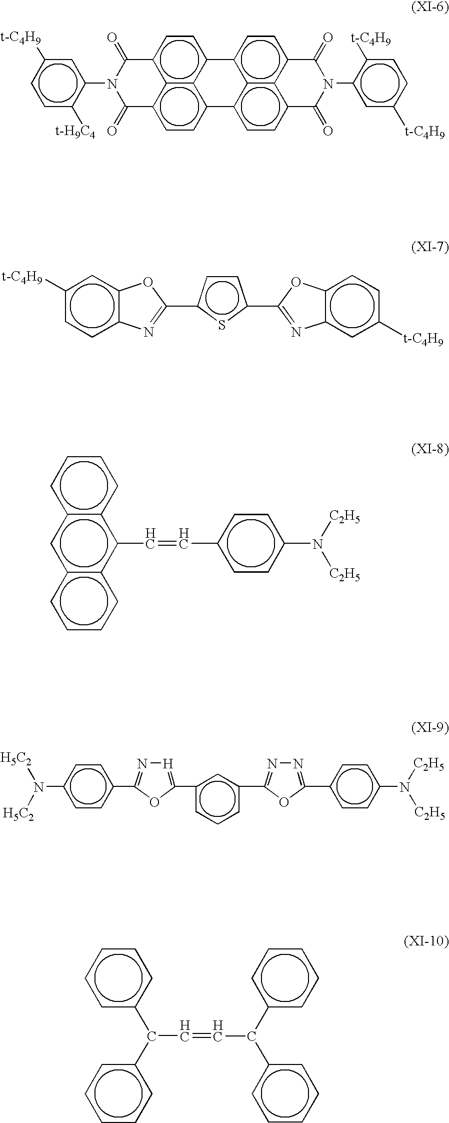

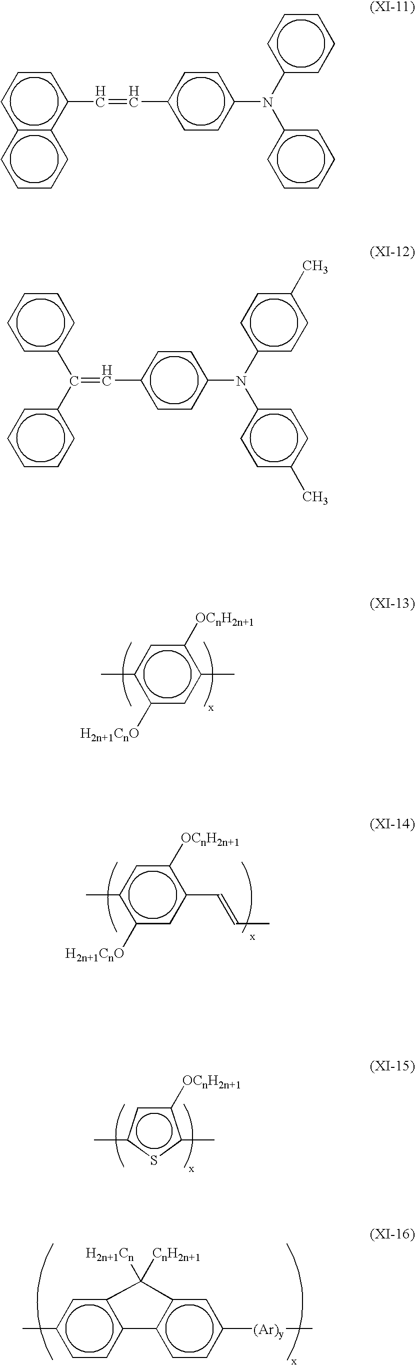

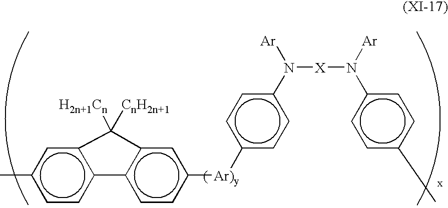

Also for the purpose of improving the durability or the light emitting efficiency of the organic EL device, the aforementioned light emitting material may be doped, as a guest material, with a dye compound different from the light emitting material. In case the light emitting layer is formed by vacuum evaporation, the doping is achieved by co-evaporation, and, in case the light emitting layer is formed by coating and drying a solution or a dispersion, the doping is achieved by mixing in such solution or dispersion. A doping proportion of the dye compound in the light emitting layer is about 0.01 to 40 wt. %, preferably 0.01 to 10 wt. %.

A dye compound employed in such doping is an organic compound showing a satisfactory mutual solubility with the light emitting material and not hindering a satisfactory film formation of the light emitting layer, and can advantageously be a DCM derivative, a quinacridone derivative, a rubrene derivative or a porphyrin derivative. Preferred specific examples include following compounds (XII-1) to (XII-4), but such examples are not restrictive.

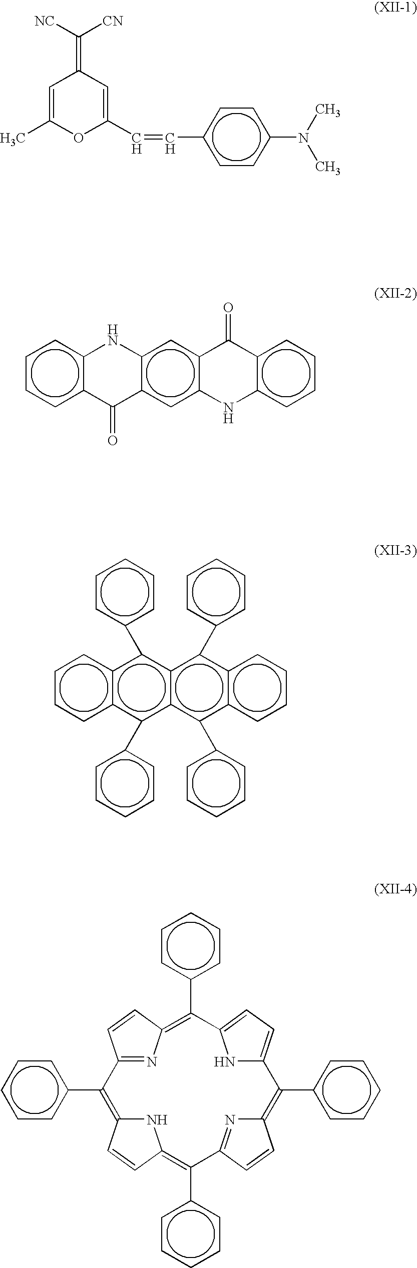

In case the light emitting layer 5 may be singly formed by the light emitting material, but may also be formed, for the purpose of further improving the electrical characteristics and the light emitting characteristics, by mixing and dispersing the charge transporting polyester in the light emitting material within a range of 1 to 50 wt. %, or by mixing and dispersing a charge transporting material other than the charge transporting polyester in the light emitting polymer within a range of 1 to 50 wt. %.

Also in case the charge transporting polymer also has a light emitting property, it may be employed as the light emitting material, and, in such case, the light emitting layer may also be formed, for the purpose of further improving the electrical characteristics and the light emitting characteristics, by mixing and dispersing a charge transporting material other than the charge transporting polyester in the light emitting material within a range of 1 to 50 wt %.

In the layered structure of the organic EL device shown in FIG. 4, the light emitting layer 7 with the charge transporting ability is preferably formed by a material which is formed by dispersing, in the aforementioned charge transporting polyester provided with a desired function (electron transporting ability or positive hole transporting ability), with the aforementioned light emitting material (XI-1) to (XI-17) as the light emitting material by 50 wt. % or less. In such case, in order to regulate the balance of the holes and the electrons injected in the organic EL device, a charge transporting material other than the charge transporting polyester may be dispersed within a range of 10 to 50 wt. %.

As such charge transporting material, in case of regulating the electron mobility, the electron transporting material can advantageously be an oxadiazole derivative, a nitro-substituted fluorenone derivative, a diphenoquinone derivative, a thiopyrandioxide derivative or a fluorenylidene methane derivative. Preferred specific examples are shown by following compounds (IX-1) to (IX-3). Also it is preferable to employ an organic compound not showing a strong electronic interaction with the charge transporting polyester, and more preferable to employ a following compound (XIII), but such example is not restrictive.

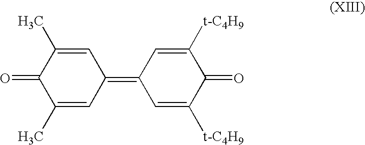

Also in case of regulating the hole mobility, the hole-transporting material can advantageously be a tetraphenylenediamine derivative, a triphenylamine derivative, a carbazole derivative, a stilbene derivative, an arylhydrazone derivative, or a porphyrin derivative, and particularly preferred specific examples are shown by following compounds (X-1) to (X-6), but a tetraphenylenediamine derivative is preferred because of a satisfactory mutual solubility with the charge transporting polyester.

In the layered structure of the organic EL device shown in FIGS. 1 to 4, the rear electrode 8 is constituted of a metal that can be vacuum evaporated and has a low work function for electron injection, particularly preferably magnesium, aluminum, silver, indium or an alloy thereof, or a metal halide or a metal oxide such as lithium fluoride or lithium oxide.

The rear electrode 8 may be provided thereon with a protective layer for avoiding deterioration of the device by moisture or oxygen. Specific examples of a material for the protective layer include a metal such as In, Sn, Pb, Au, Cu, Ag or Al, a metal oxide such as MgO, SiO₂ or TiO₂, and a resin such as polyethylene, polyurea or polyimide. The protective layer can be formed for example by vacuum evaporation, sputtering, plasma polymerization, CVD or coating.

The organic EL device shown in FIGS. 1 to 4 can be prepared in the following procedure. At first, a buffer layer 3 is formed on a transparent electrode 2 prepared in advance on a transparent insulating substrate 1. The buffer layer 3 can be prepared by vacuum evaporation with the aforementioned material, or by forming a film on the transparent electrode 2 by spin coating or dip coating with a coating liquid obtained by dissolving or dispersing such material in an organic solvent.

Then, on the buffer layer 3, a hole transport layer 4, and a light emitting layer 5 or a light emitting layer 7 with a charge transporting ability are formed according to the layer structure of the organic EL device. Then, layers are laminated in succession on these layers according to the layer structure of the organic EL device.

The hole transport layer 4, the light emitting layer 5, the electron transport layer 6, or the light emitting layer 7 with a charge transporting ability are formed, as described above, by vacuum evaporation of a material constituting such layer, or by forming a film with spin coating or dip coating of a coating liquid obtained by dissolving or dispersing such material in an organic solvent.

The hole transport layer 4, the light emitting layer 5, or the electron transport layer 6 thus formed preferably has a thickness of 0.1 μm or less, particularly preferably within a range of 0.03 to 0.08 μm. Also the light emitting layer 7 with a charge transporting ability preferably has a thickness of about 0.03 to 0.2 μm.

A dispersion state of such materials (charge transporting polyester, light emitting material and so forth) may be a molecular dispersion state or a fine particle dispersion state. In the film formation with a coating liquid, a molecular dispersion solvent has to be a common solvent for these materials in order to achieve a molecular dispersion state, and, in order to obtain a fine particle dispersion state, a dispersion solvent has to be selected in consideration of the solubility and the dispersibility of the materials. For obtaining the fine particle dispersion state, there can be utilized a ball mill, a sand mill, a paint shaker, an attriter, a homogenizer or an ultrasonic method.

Finally, an organic EL device shown in FIGS. 1 to 4 can be obtained by forming a rear electrode 8 by vacuum evaporation on the light emitting layer 5, the electron transport layer 6, or the light emitting layer 7 with a charge transporting ability.

Such organic EL device of the invention can emit light by an application of a DC voltage of 4 to 20 V with a current density of 1-200 mA/cm² between the paired electrodes.

### EXAMPLES

In the following, the present invention will be explained further with examples.

Synthesis of Charge Transporting Polyester

### Synthesis Example 1

2.0 g of a following compound (XIV-1), 8.0 g of ethylene glycol and 0.1 g of tetrabutoxytitanium were charged in a 50-ml flask and were heated under agitation for 5 hours at 190° C. under a nitrogen flow.

After the consumption of the compound (XIV-1) was confirmed, the mixture was heated at 200° C. under a pressure reduced to 0.25 mmHg for distilling off ethylene glycol, and the reaction was continued for 5 hours. Thereafter, the mixture was cooled to the room temperature, and dissolved in 50 ml of tetrahydrofuran (THF). Then the insoluble substance was filtered off with a 0.2 μm polytetrafluoroethylene (PTFE) filter, and the filtrate was subjected to a reprecipitation by dripping into 500 ml of methanol under agitation thereby precipitating a polymer. The obtained polymer was separated by filtration, washed sufficiently with methanol and dried to obtain 1.9 g of hole-transporting polyester (XIV-2).

The hole-transporting polyester (XIV-2), in a measurement of molecular weight distribution by gel permeation chromatography (GPC), showed a weight-average molecular weight Mw=7.24×10⁴ (converted as styrene), and a ratio (Mn/Mw) of a number-average molecular weight Mn and a weight-average molecular weight Mw of 1.87.

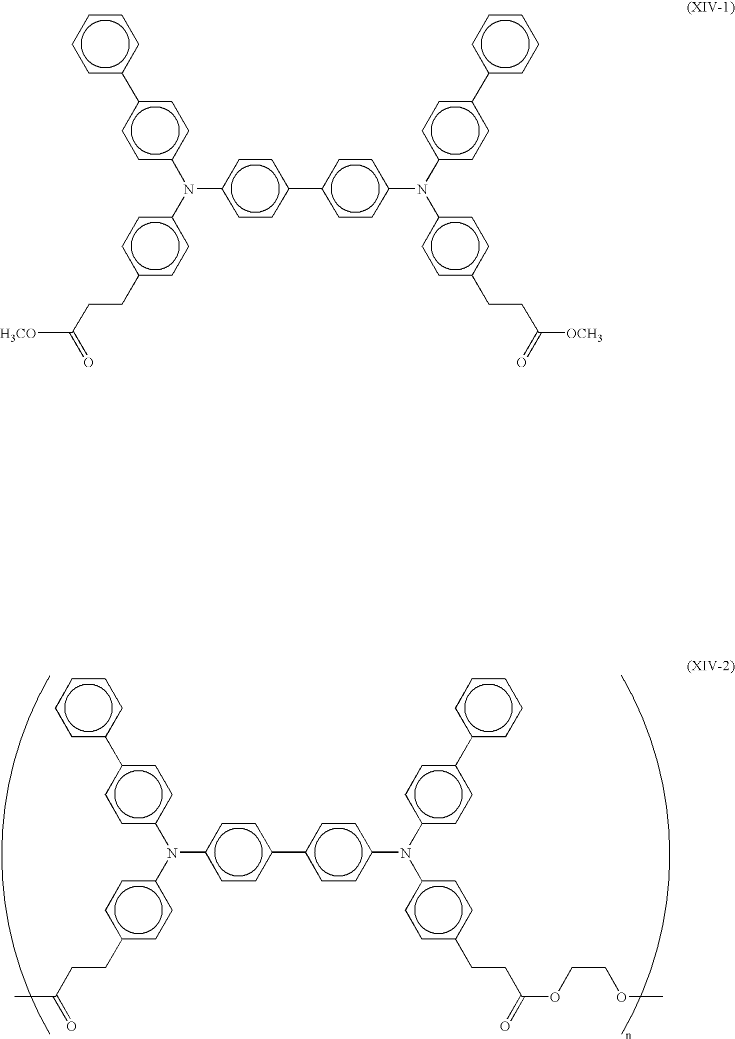

### Synthesis Example 2

2.0 g of a following compound (XV-1), 8.0 g of ethylene glycol and 0.1 g of tetrabutoxytitanium were charged in a 50-ml flask and were heated under agitation for 5 hours at 190° C. under a nitrogen flow.

After the consumption of the compound (XV-1) was confirmed, the mixture was heated at 200° C. under a pressure reduced to 0.25 mmHg for distilling off ethylene glycol, and the reaction was continued for 5 hours. Thereafter, the mixture was cooled to the room temperature, and dissolved in 50 ml of THF. Then the insoluble substance was filtered off with a 0.2 μm PTFE filter, and the filtrate was subjected to a reprecipitation by dripping into 500 ml of methanol under agitation thereby precipitating a polymer. The obtained polymer was separated by filtration, washed sufficiently with methanol and dried to obtain 1.9 g of hole-transporting polyester (XV-2).

The hole-transporting polyester (XV-2), in a measurement of molecular weight distribution by gel permeation chromatography (GPC), showed Mw=1.08×10⁵ (converted as styrene), and Mn/Mw=2.31. 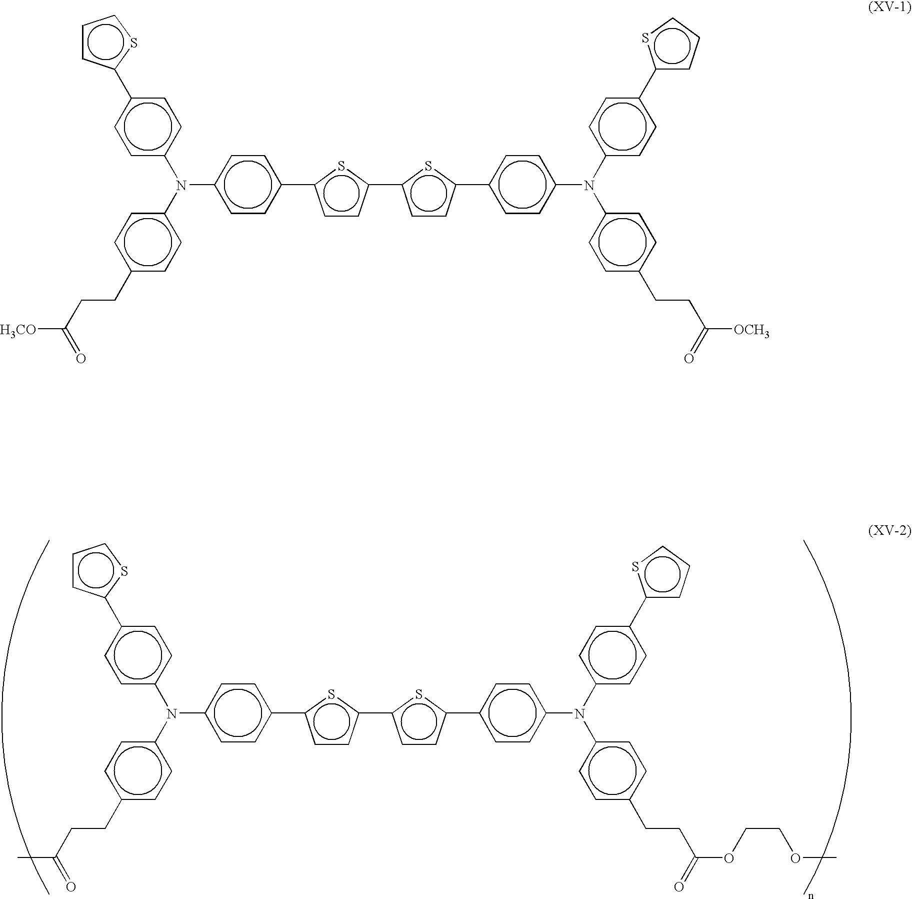
Preparation of Organic Electroluminescence Device

Then an organic electroluminescence device was prepared in the following manner, utilizing thus synthesized charge transporting polyester.

### Example 1

As a solution for forming a buffer layer, a dichloroethane solution containing a charge transporting polymer (following compound (XVI), ionization potential=5.0 eV, Mw=7.25×10⁴) by 5 wt. % was prepared and filtered with a polytetrafluoroethylene (PTFE) filter of a pore size of 0.1 μm.

Also a substrate on which a stripe-shaped ITO electrode of a width of 2 mm was formed by etching was prepared as a substrate with a transparent electrode (hereinafter called “glass substrate with ITO electrode”).

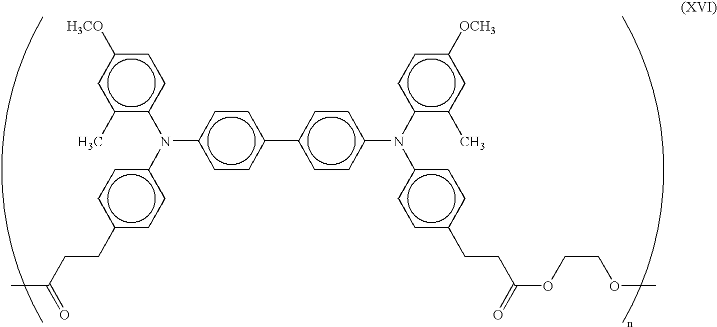

Then this solution was spin coated on the washed and dried glass substrate with the ITO electrode, on a surface of the side of the ITO electrode, to form a buffer layer of a thickness of 0.05 μm. After the buffer layer was sufficiently dried, a solution obtained by filtering, with a polytetrafluoroethylene (PTFE) filter of a pore size of 0.1 μm, a chlorobenzene solution containing a light emitting polymer [following compound (XVII), polyfluorene type, Mw≅10⁵] as a light emitting material and a charge transporting polyester [compound (XIV-2)] (Mw=7.24×10⁴) as a positive hole-transporting material by 5 wt. % was spin coated on the buffer layer to obtain a light emitting layer of a thickness of 0.03 μm.

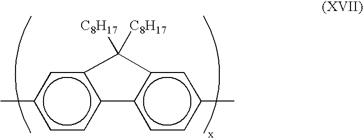

After the formed light emitting layer was sufficiently dried, a dichloroethane solution containing a charge transporting polyester [compound (XV-2)] (Mw=1.08×10⁵) as an electron-transporting material by 5 wt. % was filtered with a PTFE filter of a pore size of 0.1 μm, and was spin coated on the light emitting layer to obtain an electron transport layer of a thickness of 0.03 μm. Finally a Mg—Ag alloy was co-evaporated to form a rear electrode of a width of 2 mm and a thickness of 0.15 μm so as to cross the ITO electrode. The formed organic EL device had an effective area of 0.04 cm².

### Example 2

As a solution for forming a buffer layer, a dichloroethane solution containing a charge transporting polymer [compound (XVI), ionization potential=5.0 eV, Mw=7.25×10⁴) by 5 wt. % was prepared and filtered with a polytetrafluoroethylene (PTFE) filter of a pore size of 0.1 μm.

Then this solution was spin coated on a washed and dried glass substrate with the ITO electrode, on a surface of the side of the ITO electrode, to form a buffer layer of a thickness of 0.05 μm. After the buffer layer was sufficiently dried, a chlorobenzene solution containing a charge transporting polyester [compound (XIV-2)] (Mw=7.24×10⁴) as a positive hole-transporting material by 5 wt. % was filtered with a polytetrafluoroethylene (PTFE) filter of a pore size of 0.1 μm, and spin coated on the buffer layer to obtain a hole transport layer of a thickness of 0.01 μm.

After the formed layer was sufficiently dried, Alq3 (compound (XI-1)) as a light emitting material, purified by sublimation, was placed in a tungsten boat and evaporated by vacuum evaporation method to form a light emitting layer of a thickness of 0.05 μm on the hole transport layer. The operation was conducted at a vacuum of 10⁻⁵ Torr and a boat temperature of 300° C.

Then a dichloroethane solution containing a charge transporting polyester [compound (XV-2)] (Mw=1.08×10⁵) as an electron-transporting material by 5 wt. % was filtered with a PTFE filter of a pore size of 0.1 μm, and was spin coated on the light emitting layer to obtain an electron transport layer of a thickness of 0.03 μm. Finally a Mg—Ag alloy was co-evaporated to form a rear electrode of a width of 2 mm and a thickness of 0.15 μm so as to cross the ITO electrode. The formed organic EL device had an effective area of 0.04 cm².

### Example 3

As a solution for forming a buffer layer, a dichloroethane solution containing a charge transporting polyester [compound (XVI), ionization potential=5.0 eV, Mw=7.25×10⁴] by 5 wt. % was prepared and filtered with a polytetrafluoroethylene (PTFE) filter of a pore size of 0.1 μm. This solution was spin coated on a washed and dried glass substrate with the ITO electrode, on a surface of the side of the ITO electrode, to form a buffer layer of a thickness of 0.05 μm.

After the buffer layer was sufficiently dried, a chlorobenzene solution containing a charge transporting polyester [compound (XIV-2),Mw=7.24×10⁴] as a hole-transporting material by 5 wt. % was filtered with a polytetrafluoroethylene (PTFE) filter of a pore size of 0.1 μm, and spin coated on the buffer layer to obtain a hole transport layer of a thickness of 0.01 μm.

After the formed layer was sufficiently dried, Alq3 (compound (XI-1)) as a light emitting material, purified by sublimation, was placed in a tungsten boat and evaporated by vacuum evaporation method to form a light emitting layer of a thickness of 0.05 μm on the positive hole transport layer. The operation was conducted at a vacuum of 10⁻⁵ Torr and a boat temperature of 300° C. Finally a Mg—Ag alloy was co-evaporated to form a rear electrode of a width of 2 mm and a thickness of 0.15 μm so as to cross the ITO electrode. The formed organic EL device had an effective area of 0.04 cm².

### Example 4

As a solution for forming a buffer layer, a dichloroethane solution containing a charge transporting polyester (following compound (XVI), ionization potential=5.0 eV, Mw=7.25×10⁴) by 5 wt. % was prepared and filtered with a polytetrafluoroethylene (PTFE) filter of a pore size of 0.1 μm. Then this solution was spin coated on a washed and dried glass substrate with an ITO electrode, on a surface of the side of the ITO electrode, to form a buffer layer of a thickness of 0.05 μm, which was then dried sufficiently.

Then a chlorobenzene solution obtained by mixing 0.5 parts by weight of a charge transporting polyester [compound (XIV-2),Mw=7.24×10⁴] as a positive hole-transporting material and 0.1 parts by weight of PPV (polyphenylenevinylene) compound (following compound (XVIII)) and dissolving such mixture by 10 wt. % was filtered with a polytetrafluoroethylene (PTFE) filter of a pore size of 0.1 μm, to obtain a solution for forming a light emitting layer.

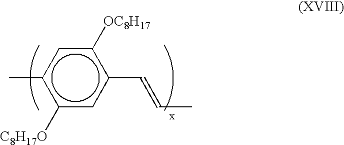

Then this solution was spin coated on the washed and dried glass substrate with the ITO electrode, on a surface of the side of the ITO electrode, to form a light emitting layer with a charge transporting ability of a thickness of 0.05 μm, and finally a Mg—Ag alloy was co-evaporated to form a rear electrode of a width of 2 mm and a thickness of 0.15 μm so as to cross the ITO electrode. The formed organic EL device had an effective area of 0.04 cm².

### Example 5

An organic EL device was prepared in the same manner as in Example 1, except that Baytron P (manufactured by Bayer AG; a mixed aqueous dispersion containing polyethylene dioxide thiophene [compound (III), ionization potential=5.1-5.2 eV] and polystyrenesulfonic acid) was employed as a solution for forming the buffer layer and was spin coated on the washed and dried glass substrate with the ITO electrode, on a surface of the side of the ITO electrode, to form a buffer layer of a thickness of 0.05 μm.

### Example 6

An organic EL device was prepared in the same manner as in Example 2, except that Baytron P (manufactured by Bayer AG; a mixed aqueous dispersion containing polyethylene dioxide thiophene [compound (III), ionization potential=5.1-5.2 eV] and polystyrenesulfonic acid) was employed as a solution for forming the buffer layer and was spin coated on the washed and dried glass substrate with the ITO electrode, on a surface of the side of the ITO electrode, to form a buffer layer of a thickness of 0.05 μm.

### Example 7

An organic EL device was prepared in the same manner as in Example 3, except that Baytron P (manufactured by Bayer AG; a mixed aqueous dispersion containing polyethylene dioxide thiophene [compound (III), ionization potential=5.1-5.2 eV] and polystyrenesulfonic acid) was employed as a solution for forming the buffer layer and was spin coated on the washed and dried glass substrate with the ITO electrode, on a surface of the side of the ITO electrode, to form a buffer layer of a thickness of 0.05 μm.

### Example 8

An organic EL device was prepared in the same manner as in Example 4, except that Baytron P (manufactured by Bayer AG; a mixed aqueous dispersion containing polyethylene dioxide thiophene [compound (III), ionization potential=5.1-5.2 eV] and polystyrenesulfonic acid) was employed as a solution for forming the buffer layer and was spin coated on the washed and dried glass substrate with the ITO electrode, on a surface of the side of the ITO electrode, to form a buffer layer of a thickness of 0.05 μm.

### Example 9

A solution for forming a buffer layer was prepared by filtering a chlorobenzene solution containing, as a charge transporting material, a following compound (XIX) (MTDATA (4,4′,4″-tris(3-methylphenylphenylamino)triphenyl-amine), ionization potential=5.1 eV, an example of the general formula (IV)) by 5 wt. % with a polytetrafluoroethylene (PTFE) filter of a pore size of 0.1 μm.

Then an organic EL device was prepared in the same manner as in Example 1, except that this solution was spin coated on the washed and dried glass substrate with the ITO electrode, on a surface of the side of the ITO electrode, to form a buffer layer of a thickness of 0.05 μm.

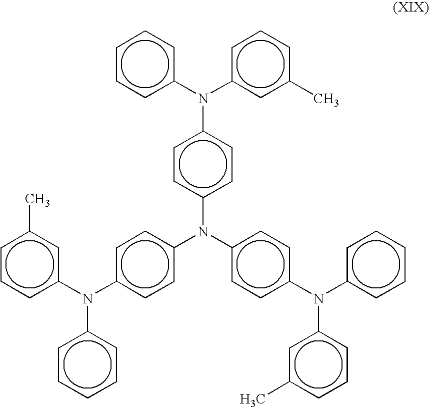

### Example 10

A solution for forming a buffer layer was prepared by filtering a chlorobenzene solution containing a charge transporting material [compound (XIX), ionization potential=5.1 eV] by 5 wt. % with a polytetrafluoroethylene (PTFE) filter of a pore size of 0.1 μm.

Then an organic EL device was prepared in the same manner as in Example 2, except that this solution was spin coated on the washed and dried glass substrate with the ITO electrode, on a surface of the side of the ITO electrode, to form a buffer layer of a thickness of 0.05 μm.

### Example 11

A solution for forming a buffer layer was prepared by filtering a chlorobenzene solution containing a charge transporting material [compound (XIX), ionization potential=5.1 eV] by 5 wt. % with a polytetrafluoroethylene (PTFE) filter of a pore size of 0.1 μm.

Then an organic EL device was prepared in the same manner as in Example 3, except that this solution was spin coated on the washed and dried glass substrate with the ITO electrode, on a surface of the side of the ITO electrode, to form a buffer layer of a thickness of 0.05 μm.

### Example 12

A solution for forming a buffer layer was prepared by filtering a chlorobenzene solution containing a charge transporting material [compound (XIX), ionization potential=5.1 eV] by 5 wt. % with a polytetrafluoroethylene (PTFE) filter of a pore size of 0.1 μm.

Then an organic EL device was prepared in the same manner as in Example 4, except that this solution was spin coated on the washed and dried glass substrate with the ITO electrode, on a surface of the side of the ITO electrode, to form a buffer layer of a thickness of 0.05 μm.

### Example 13

An organic EL device was prepared in the same manner as in Example 1, except that a charge transporting material represented by the formula (V) (ionization potential=4.8 eV), placed in a tungsten boat, was evaporated onto a washed and dried glass substrate with an ITO electrode, on a surface of the side of the ITO electrode, to form a buffer layer of a thickness of 0.05 μm.

### Example 14

An organic EL device was prepared in the same manner as in Example 2, except that a charge transporting material represented by the formula (V) (ionization potential=4.8 eV), placed in a tungsten boat, was evaporated onto a washed and dried glass substrate with an ITO electrode, on a surface of the side of the ITO electrode, to form a buffer layer of a thickness of 0.05 μm.

### Example 15

An organic EL device was prepared in the same manner as in Example 3, except that a charge transporting material represented by the formula (V) (ionization potential=4.8 eV), placed in a tungsten boat, was evaporated onto a washed and dried glass substrate with an ITO electrode, on a surface of the side of the ITO electrode, to form a buffer layer of a thickness of 0.05 μm.

### Example 16

An organic EL device was prepared in the same manner as in Example 4, except that a charge transporting material represented by the formula (V) (ionization potential=4.8 eV), placed in a tungsten boat, was evaporated onto a washed and dried glass substrate with an ITO electrode, on a surface of the side of the ITO electrode, to form a buffer layer of a thickness of 0.05 μm.

### Comparative Example 1

An organic EL device was prepared in the same manner as in Example 1, except that a light emitting layer and subsequent structures were directly formed, without forming the buffer layer, onto a glass substrate with an ITO electrode, on a surface of the side of the ITO electrode.

### Comparative Example 2

An organic EL device was prepared in the same manner as in Example 2, except that a hole transporting layer and subsequent structures were directly formed, without forming the buffer layer, onto a glass substrate with an ITO electrode, on a surface of the side of the ITO electrode.

### Comparative Example 3

An organic EL device was prepared in the same manner as in Example 3, except that a hole transporting layer and subsequent structures were directly formed, without forming the buffer layer, onto a glass substrate with an ITO electrode, on a surface of the side of the ITO electrode.

### Comparative Example 4

An organic EL device was prepared in the same manner as in Example 4, except that a light emitting layer having a charge transporting ability and subsequent structures were directly formed, without forming the buffer layer, onto a glass substrate with an ITO electrode, on a surface of the side of the ITO electrode.

### Comparative Example 5

An organic EL device was prepared in the same manner as in Example 1, except that, the charge transporting polyester (compound (XVI)) in the buffer layer was replaced by a compound (XXII), and as the hole-transporting material in the light emitting layer, the charge transporting polyester (compound (XIV-2) was replaced by a charge transporting polymer having a vinylic structure (following compound (XX), Mw=5.46×10⁴ (converted as styrene)) and the light emitting layer was formed on the glass substrate with ITO electrode, without forming a buffer layer, and, as the electron transporting material, the charge transporting polyester (compound (XV-2)) was replaced by an oxadiazole derivative (compound (IX-1)) purified by sublimation, which was placed in a tungsten boat and evaporated by vacuum evaporation method (with a vacuum of 10⁻⁵ Torr and a boat temperature of 300° C. at the evaporation) to form an electron transport layer of a thickness of 0.03 μm on the light emitting layer.

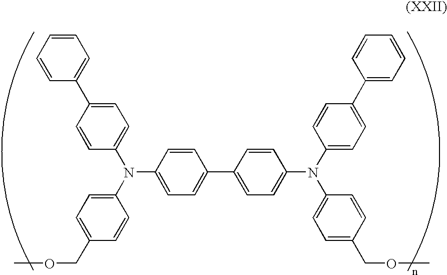

### Comparative Example 6

An organic EL device was prepared in the same manner as in Example 3, except that, the charge transporting polyester (compound (XVI)) in the buffer layer was replaced by a compound (XXII), and as the hole-transporting material, the charge transporting polyester (compound (XIV-2) was replaced by a charge transporting polymer having a vinylic structure [following compound (XX), Mw=5.46×10⁴ (converted as styrene)] and the hole transport layer was formed on the glass substrate with ITO electrode, without forming a buffer layer.

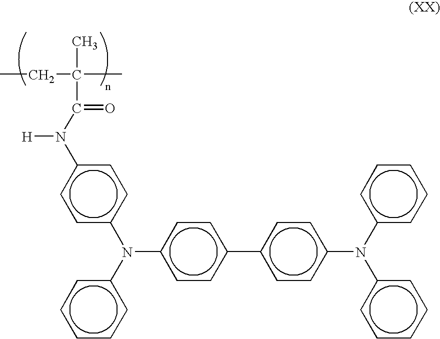

### Comparative Example 7

An organic EL device was prepared in the same manner as in Example 3, except that, the charge transporting polyester (compound (XVI)) in the buffer layer was replaced by a compound (XXII), and as the hole-transporting material, the charge transporting polyester (compound (XIV-2) was replaced by a charge transporting polymer having a polycarbonate structure [following compound (XXI), Mw=7.83×10⁴ (converted as styrene)] and the hole transport layer was formed on the glass substrate with ITO electrode, without forming a buffer layer.

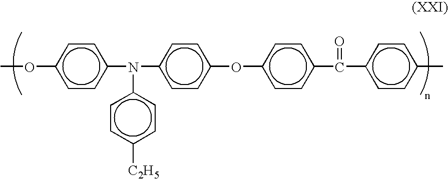

### Comparative Example 8

A device was prepared in the same manner as in Example 6, except that, as the hole-transporting material, the charge transporting polyester (compound (XIV-2) was replaced by a charge transporting polymer having a vinylic structure (following compound (XX), Mw=5.46×10⁴ (converted as styrene)) which was spin coated on the buffer layer to form a positive hole transport layer of a thickness of 0.01 μm and, as the electron transporting material, the charge transporting polyester (compound (XV-2)) was replaced by an oxadiazole derivative (compound (IX-1)) purified by sublimation, which was placed in a tungsten boat and evaporated by vacuum evaporation method (with a vacuum of 10⁻⁵ Torr and a boat temperature of 300° C. at the evaporation) to form an electron transport layer of a thickness of 0.03 μm on the light emitting layer.

### Comparative Example 9

A device was prepared in the same manner as in Example 10, except that, as the hole-transporting material, the charge transporting polyester (compound (XIV-2) was replaced by a charge transporting polymer having a vinylic structure (following compound (XX), Mw=5.46×10⁴ (converted as styrene)) which was spin coated on the buffer layer to form a positive hole transport layer of a thickness of 0.01 μm, and, as the electron transporting material, the charge transporting polyester (compound (XV-2)) was replaced by an oxadiazole derivative (compound (IX-1)) purified by sublimation, which was placed in a tungsten boat and evaporated by vacuum evaporation method (with a vacuum of 10⁻⁵ Torr and a boat temperature of 300° C. at the evaporation) to form an electron transport layer of a thickness of 0.03 μm on the light emitting layer.

### Comparative Example 10

A device was prepared in the same manner as in Example 14, except that, as the hole-transporting material, the charge transporting polyester (compound (XIV-2) was replaced by a charge transporting polymer having a polycarbonate structure [compound (XXI), Mw=7.83×10⁴ (converted as styrene)] which was spin coated on the buffer layer to form a hole transport layer of a thickness of 0.01 μm, and, as the electron transporting material, the charge transporting polyester (compound (XV-2)) was replaced by an oxadiazole derivative (compound (IX-1)) purified by sublimation, which was placed in a tungsten boat and evaporated by vacuum evaporation method (with a vacuum of 10⁻⁵ Torr and a boat temperature of 300° C. at the evaporation) to form an electron transport layer of a thickness of 0.03 μm on the light emitting layer.

(Evaluation)

The organic EL device, prepared as described above, was subjected to a light emission by an application of a DC voltage with a positive side at the ITO electrode and a negative side at the Mg—Ag rear electrode in vacuum (133.3×10⁻³ Pa (10⁻⁵ Torr), and evaluations were made on a start-up voltage (driving voltage), a maximum luminance and a driving current density at the maximum luminance. Obtained results are shown in Table 1.

Also a light-emitting life of the organic EL device was measured in dry nitrogen. A current was selected so as to obtain an initial luminance of 50 cd/m² and a light-emitting device life (hour) was defined by a time at which the luminance decreased to a half of the initial value under a constant-current drive. The device life is also shown in Table 1.

TABLE 1

| | | maximum | | |
|---|---|---|---|---|
| | start-up | luminance | driving current | device life |
| | voltage | (cd/m²) | density (mA/cm2) | (hour) |
| Example 1 | 3.5 | 850 | 7.2 | 44 |
| Example 2 | 3.1 | 1020 | 6.5 | 70 |
| Example 3 | 3.0 | 950 | 7.0 | 61 |
| Example 4 | 3.6 | 790 | 7.7 | 53 |
| Example 5 | 3.3 | 870 | 7.1 | 41 |
| Example 6 | 3.0 | 1010 | 6.5 | 69 |
| Example 7 | 3.0 | 940 | 7.1 | 60 |
| Example 8 | 3.4 | 800 | 7.5 | 55 |
| Example 9 | 3.7 | 830 | 6.9 | 39 |
| Example 10 | 3.3 | 1000 | 6.3 | 65 |
| Example 11 | 3.1 | 940 | 6.9 | 58 |
| Example 12 | 3.5 | 800 | 7.5 | 49 |
| Example 13 | 3.3 | 880 | 7.0 | 40 |
| Example 14 | 3.0 | 1020 | 6.8 | 70 |
| Example 15 | 3.0 | 950 | 6.9 | 62 |
| Example 16 | 3.3 | 810 | 7.2 | 56 |
| Comp. Ex. 1 | 4.4 | 800 | 7.6 | 34 |
| Comp. Ex. 2 | 4.2 | 980 | 6.8 | 35 |
| Comp. Ex. 3 | 3.9 | 900 | 7.5 | 32 |
| Comp. Ex. 4 | 4.7 | 760 | 7.9 | 39 |
| Comp. Ex. 5 | 3.2 | 560 | 8.0 | 25 |
| Comp. Ex. 6 | 3.1 | 780 | 10.1 | 56 |
| Comp. Ex. 7 | 3.3 | 850 | 9.1 | 60 |
| Comp. Ex. 8 | 3.4 | 540 | 7.8 | 31 |
| Comp. Ex. 9 | 3.5 | 670 | 8.9 | 35 |
| Comp. Ex. 10 | 3.4 | 700 | 9.0 | 41 |

As will be apparent from Table 1, the organic EL devices of the invention shown in Examples 1-16, improved in the charge injecting property and the charge balance by the formation of the buffer layer of a charge injecting ability in contact with the anode (ITO electrode), showed stable characteristics of a higher luminance and a higher efficiency, in comparison with the organic EL devices of Comparative Examples 1-4, not provided with such buffer layer.

Also as will be apparent from a comparison of Examples 1 and 3 with Comparative Examples 5-7, also in case of forming a buffer layer free from a low-molecular component which causes the bleeding phenomenon, Examples 1 and 3 employing the charge transporting polyester of the invention in the electron transport layer or the hole transport layer were superior in the device life and the light-emitting luminance.

Also in case of forming a buffer layer containing a low-molecular component which causes the bleeding phenomenon as in Examples 6, 10 and 14 and Comparative Examples 8-10, Examples 6, 10 and 14 employing the charge transporting polyester of the invention in the electron transport layer or the hole transport layer were superior in the device life and the light-emitting luminance. This is presumably because the bleeding from the buffer layer was suppressed by the charge transporting polyester present in a layer provided on the buffer layer. In addition, pinholes or peeling defects at the film formation were not generated in any of Examples.

Furthermore, the organic EL device of the invention, in which satisfactory thin films can be formed by spin coating or dip coating at the preparation, shows little defects such as pinholes, can be easily formed in a large area and can provide excellent durability and excellent light emission characteristics.

What is claimed is:

1. An organic electroluminescence device comprising:
an organic compound layer sandwiched between a pair of electrodes which are constituted of an anode and a cathode and of which at least one is transparent or semi-transparent;
wherein the organic compound layer is constituted by two or more layers at least including a light emitting layer and a buffer layer;
at least one layer of the organic compound layers contains at least one charge-transporting polyester, which includes a repeating unit containing, as a partial structure, at least one selected from the structures represented by following general formulas (I-1) and (I-2); and
the buffer layer is provided adjacent to the anode and contains at least a charge injecting material: 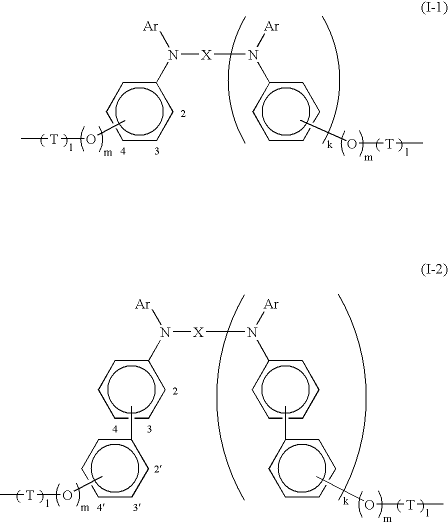
wherein, in the general formulas (I-1) and (I-2), Ar represents a substituted or non-substituted monovalent aromatic group; X represents a substituted or non-substituted divalent aromatic group; k, m and l each represents 0 or 1; and T represents a linear divalent hydrocarbon with 1 to 6 carbon atoms or a branched hydrocarbon with 2 to 10 carbon atoms.

2. An organic electroluminescence device according to claim 1, wherein at least one of the charge injecting materials has an ionization potential of 5.2 eV or less.

3. An organic electroluminescence device according to claim 1, wherein at least one of the charge injecting materials is a charge transporting polymer having at least one selected from structural units represented by following general formulas (II-1) to (II-4): 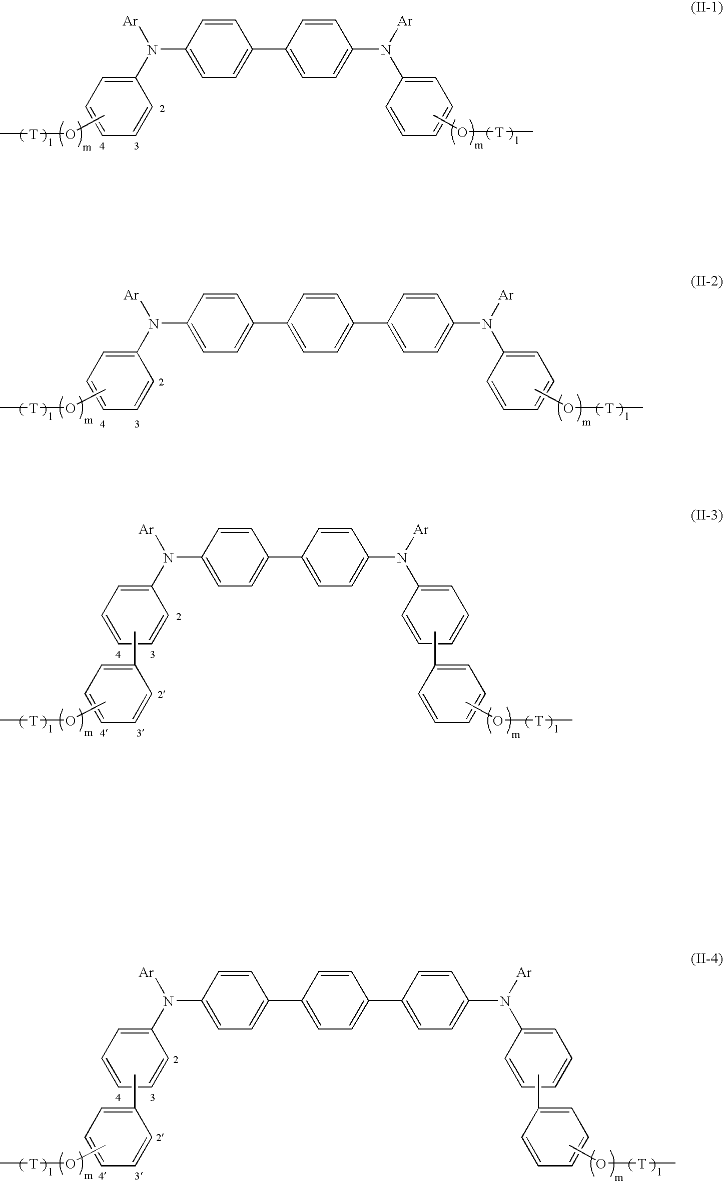
wherein, in the formulas (II-1) to (II-4), Ar represents a substituted or non-substituted monovalent aromatic group; m and l each represents 0 or 1; and T represents a linear divalent hydrocarbon with 1 to 6 carbon atoms or a branched hydrocarbon with 2 to 10 carbon atoms.

4. An organic electroluminescence device according to claim 1, wherein at least one of the charge injecting materials is a charge-transporting polymer having a structural unit represented by a following general formula (III): 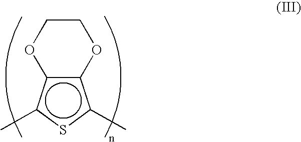
wherein, in the general formula (III), n represents an integer within a range of 100 to 10,000.

5. An organic electroluminescence device according to claim 1, wherein at least one of the charge injecting materials is a charge-transporting material represented by a following general formula (IV): 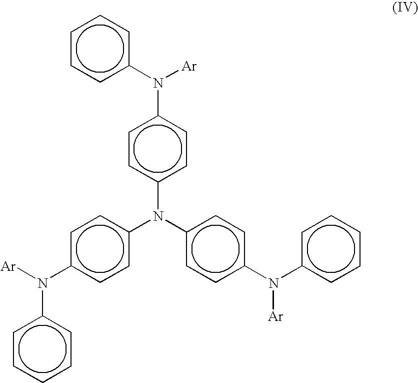
wherein, in the general formula (IV), Ar represents a substituted or non-substituted phenyl group, a substituted or non-substituted 1-naphthyl group, or a substituted or non-substituted 2-naphthyl group.

6. An organic electroluminescence device according to claim 1, wherein at least one of the charge injecting materials is a charge-transporting material represented by a following general formula (V):

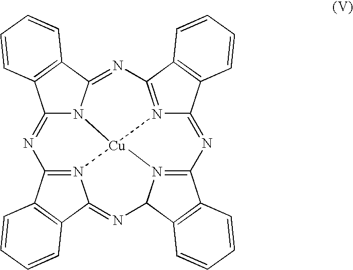

7. An organic electroluminescence device according to claim 1, wherein the organic compound layer is constituted at least by the light emitting layer, the buffer layer and an electron transport layer;
at least one of the light emitting layer or the electron transport layer contains at least one charge-transporting polyester including a repeating unit containing, as a partial structure, at least one selected from the structures represented by the general formulas (I-1) and (I-2); and
the buffer layer is provided between the anode and the light emitting layer.

8. An organic electroluminescence device according to claim 7, wherein the light emitting layer includes a charge transporting material other than the charge transporting polyester.

9. An organic electroluminescence device according to claim 7, wherein the electron transport layer further includes a charge transporting material other than the charge transporting polyester.

10. An organic electroluminescence device according to claim 9, wherein the charge transporting material other than the charge transporting polyester is at least one selected from the group consisting of an oxadiazole derivative, a nitro-substituted fluorenone derivative, a diphenoquinone derivative, a thiapyran dioxide derivative, and a fluorenylidene methane derivative.

11. An organic electroluminescence device according to claim 1, wherein the organic compound layer is constituted at least by the light emitting layer, the buffer layer, a hole transport layer and an electron transport layer;
at least one of the hole transport layer or the electron transport layer contains at least one charge-transporting polyester including a repeating unit containing, as a partial structure, at least one selected from the structures represented by the general formulas (I-1) and (I-2); and
the buffer layer is provided between the anode and the hole transport layer.

12. An organic electroluminescence device according to claim 11, wherein the light emitting layer further includes a charge transporting material other than the charge transporting polyester.

13. An organic electroluminescence device according to claim 1, wherein the organic compound layer is constituted at least by the light emitting layer, the buffer layer and a hole transport layer;
at least one of the hole transport layer or the light emitting layer contains at least one charge-transporting polyester including a repeating unit containing, as a partial structure, at least one selected from the structures represented by the general formulas (I-1) and (I-2); and
the buffer layer is provided between the anode and the hole transport layer.

14. An organic electroluminescence device according to claim 13, wherein the light emitting layer further includes a charge transporting material other than the charge transporting polyester.

15. An organic electroluminescence device according to claim 13, wherein the hole transport layer further includes a hole transporting material other than the charge transporting polyester.

16. An organic electroluminescence device according to claim 15, wherein the hole transporting material other than the charge transporting polyester has at least one selected from structures represented by following general formulas (X-1) to (X-6);

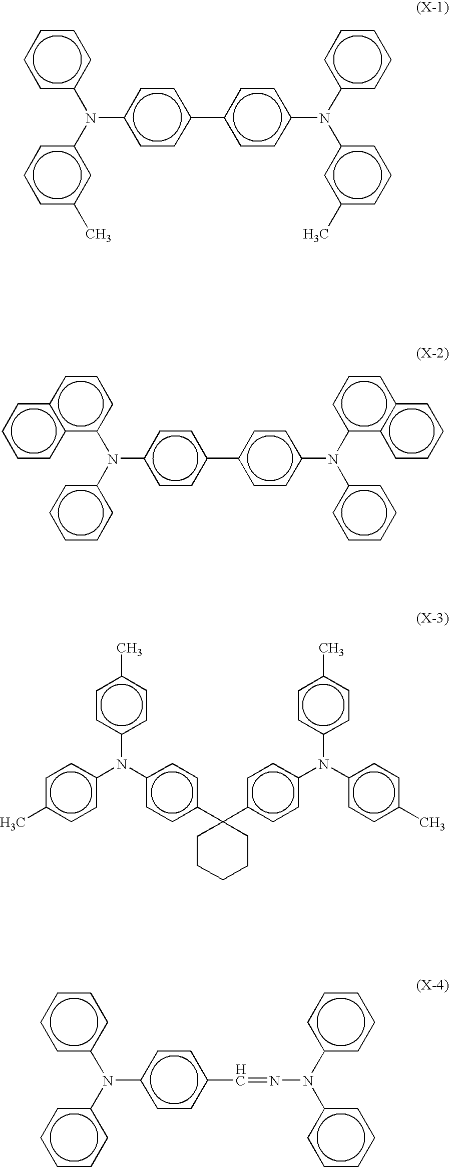

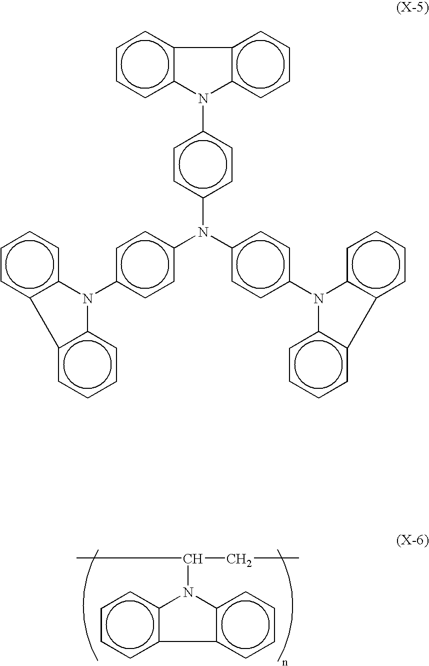

17. An organic electroluminescence device according to claim 1, wherein the organic compound layer is constituted solely by the light emitting layer and the buffer layer;
the light emitting layer is a light emitting layer having a charge transporting ability, which contains at least one charge-transporting polyester including a repeating unit containing, as a partial structure, at least one selected from the structures represented by the general formulas (I-1) and (I-2); and
the buffer layer is provided between the anode and the light emitting layer having the charge transporting ability.

18. An organic electroluminescence device according to claim 17, wherein the light emitting layer having the charging transporting ability includes a charge transporting material other than the charge transporting polyester.

19. An organic electroluminescence device according to claim 1, wherein the charge-transporting polyester including a repeating unit containing, as a partial structure, at least one selected from the structures represented by the general formulas (I-1) and (I-2) is a charge-transporting polyester represented by a following general formula (VI-1) or (VI-2): 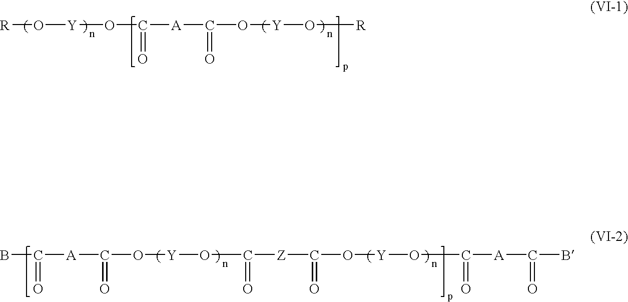
wherein, in the formulas (VI-1) and (VI-2), A represents at least one selected from the structures represented by the general formulas (I-1) and (I-2); R represents a hydrogen atom, an alkyl group, a substituted or non-substituted aryl group or a substituted or non-substituted aralkyl group; Y represents a divalent alcohol residue; Z represents a divalent carboxylic acid residue; B and B′ each independently represent —O—(Y—O)ₙ—R or —O—(Y—O)ₙ—CO-Z—CO—O—R′ (in which R, Y and Z have the same meanings as above; and R′ represents an alkyl group, a substituted or non-substituted aryl group or a substituted or non-substituted aralkyl group); n represents an integer of 1 through 5; and p represents an integer of 5 through 5,000.
